(19) United States
(12) Patent Application Publication
(10) Pub. No.: US 2025/0298792 A1
(43) Pub. Date: Sep. 25, 2025

(54) GRAMMAR POWERED RETRIEVAL AUGMENTED GENERATION FOR DOMAIN SPECIFIC LANGUAGES

(71) Applicant: Palo Alto Networks, Inc., Santa Clara, CA (US)

(72) Inventors: Alok Tongaonkar, San Jose, CA (US); Gaspar Modelo-Howard, Fremont, CA (US); Chandra Biksheswaran Mouleeswaran, Cupertino, CA (US); Sathya Prakash Rajagopal, San Jose, CA (US)

(21) Appl. No.: 18/621,872

(22) Filed: Mar. 29, 2024

Related U.S. Application Data
(60) Provisional application No. 63/568,851, filed on Mar. 22, 2024.

(51) Int. Cl. G06F 16/242; G06F 21/57

(52) U.S. Cl. CPC G06F 16/243; G06F 16/2433; G06F 21/577

(57) ABSTRACT

Techniques for grammar powered retrieval augmented generation for domain specific languages are disclosed. In some embodiments, a system, a process, and/or a computer program product for grammar powered retrieval augmented generation for domain specific languages includes automatically generating a seed dataset for a domain specific language (DSL) (e.g., a resource query language (RQL), and wherein the RQL is generated for RQL for multi-domain security applications); expanding the seed dataset for the DSL using a Large Language Model (LLM); and validating the seed dataset for the DSL, wherein the seed dataset for the DSL is input to the LLM for fine tune training of the LLM (e.g., fine-tuned for a cloud security application).

### CROSS REFERENCE TO OTHER APPLICATIONS

This application claims priority to U.S. Provisional Patent Application No. 63/568,851 entitled AI-POWERED MACROS TO PROCESS COMPLEX NLP QUERIES ACROSS DOMAINS filed Mar. 22, 2024, which is incorporated herein by reference for all purposes.

### BACKGROUND OF THE INVENTION

A firewall generally protects networks from unauthorized access while permitting authorized communications to pass through the firewall. A firewall is typically a device or a set of devices, or software executed on a device, such as a computer, which provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRA WINGS

Various embodiments of the invention are disclosed in the following detailed description and the accompanying drawings.

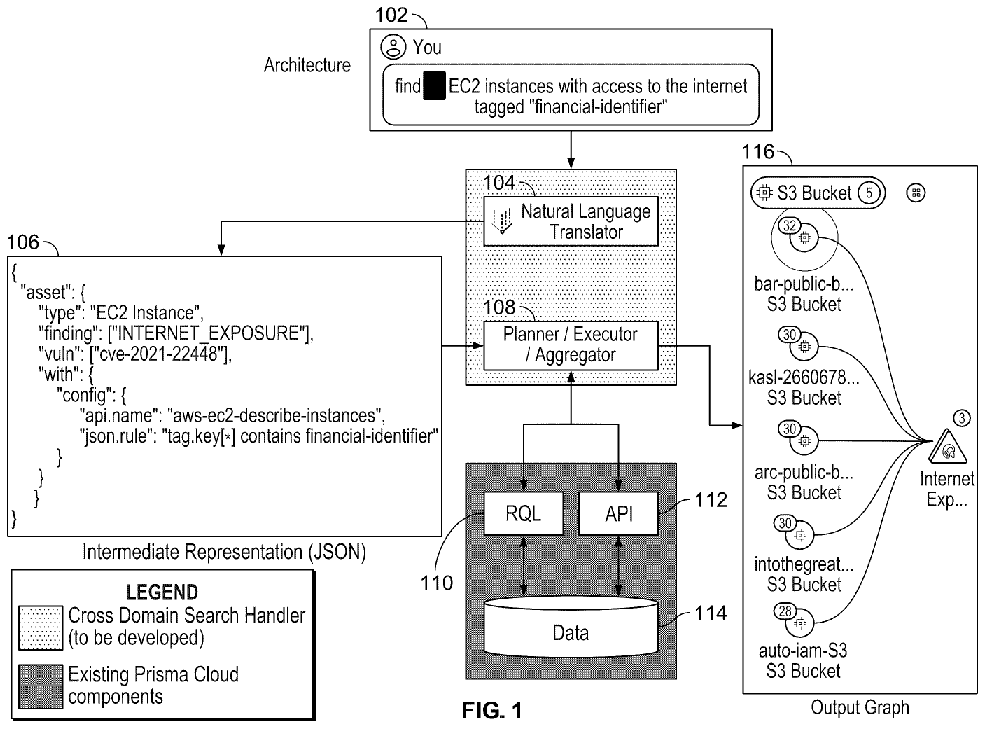

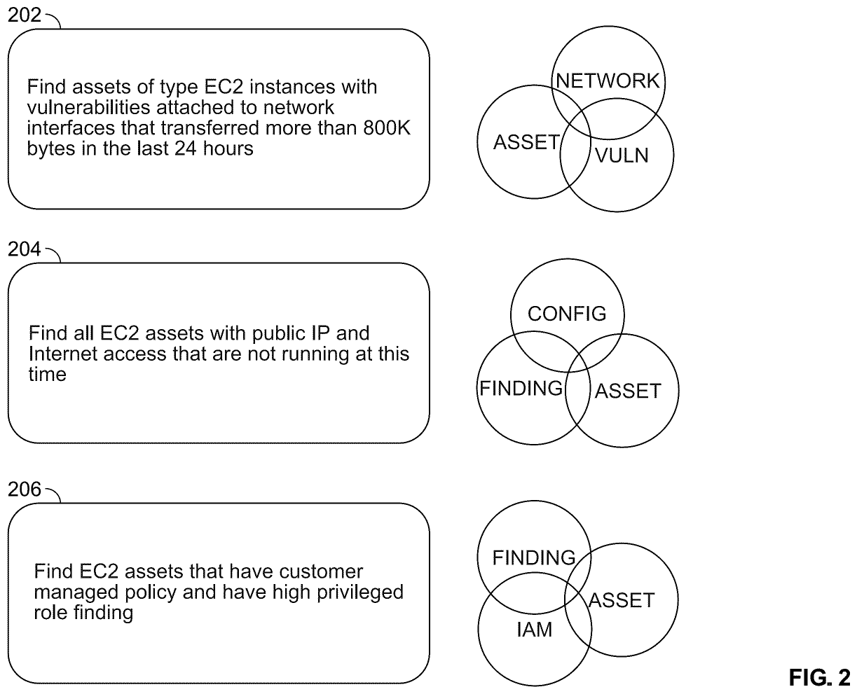

FIG. 1 illustrates an overview of an architecture for AI-powered macros to process complex natural language processing (NLP) across domains in accordance with some embodiments.

FIG. 2 illustrates multi-domain query examples in accordance with some embodiments.

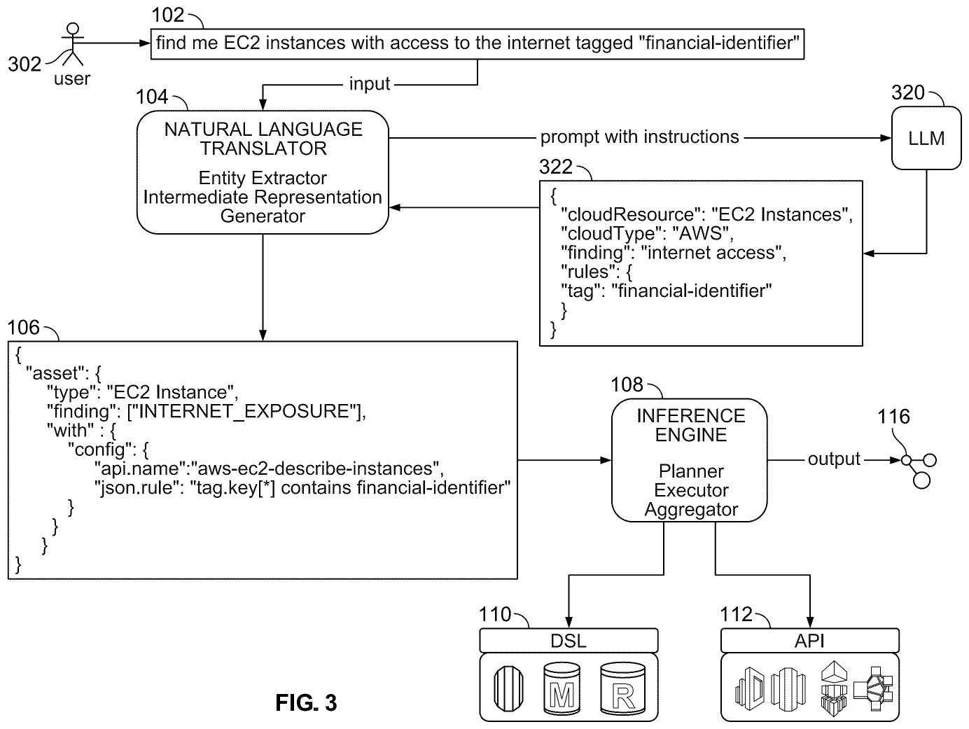

FIG. 3 illustrates a processing view for a multi-domain search architecture for AI-powered macros to process complex NLP across domains in accordance with some embodiments.

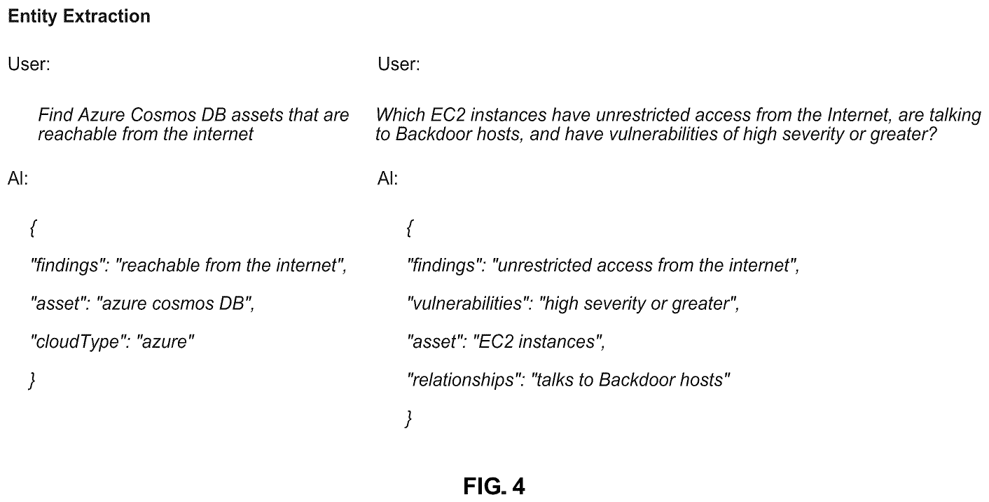

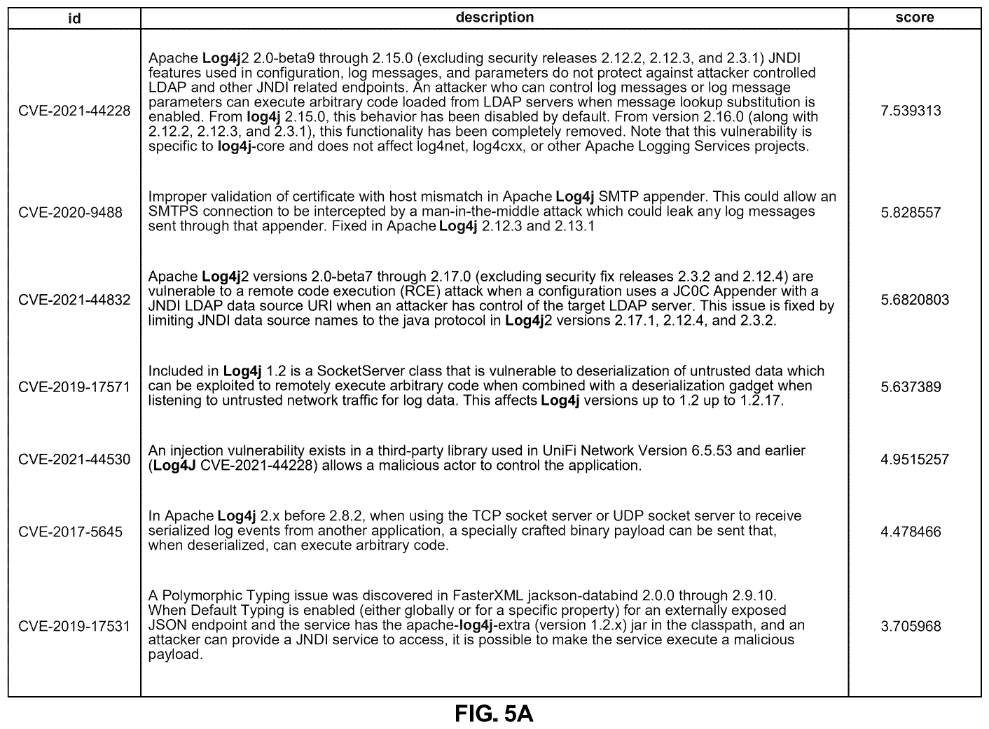

FIG. 4 illustrates an example entity extraction in accordance with some embodiments.

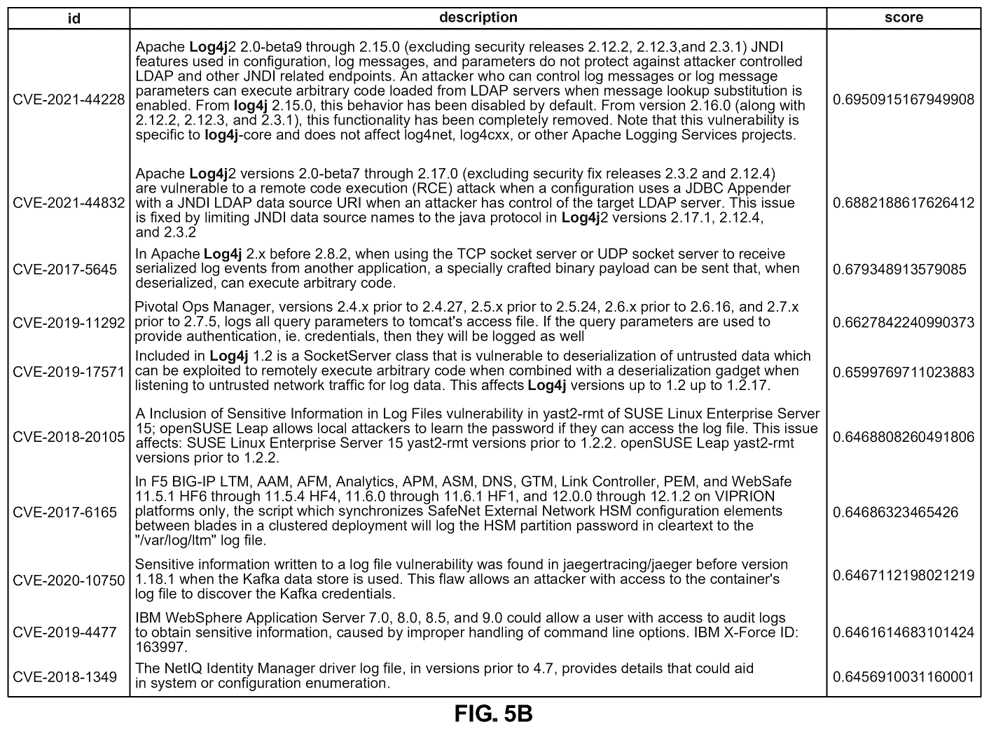

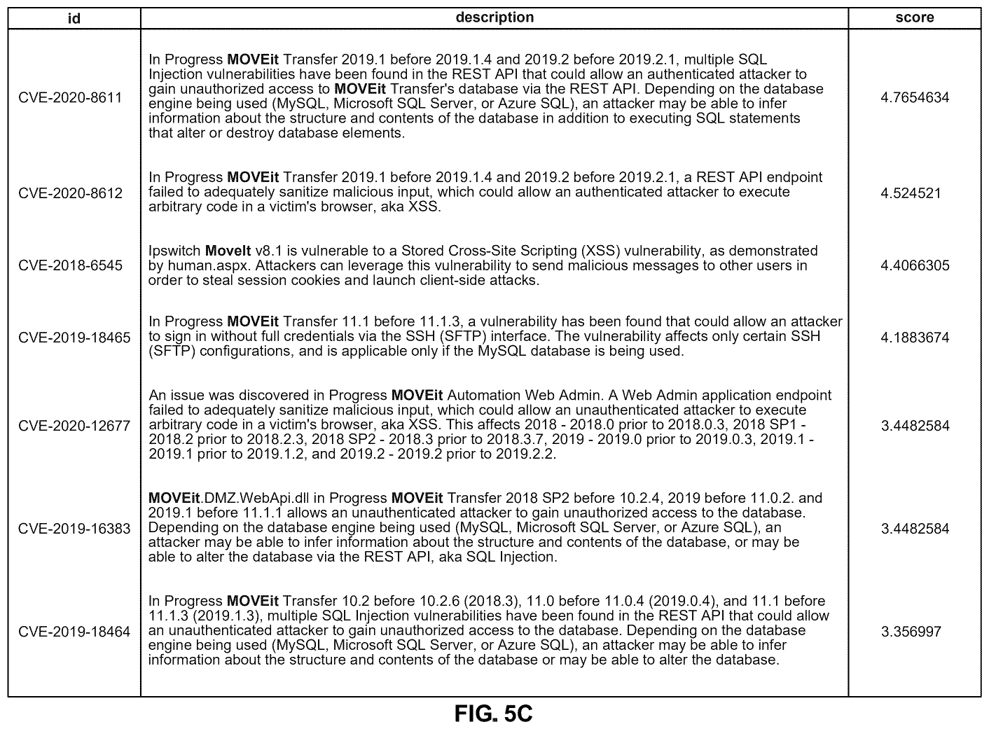

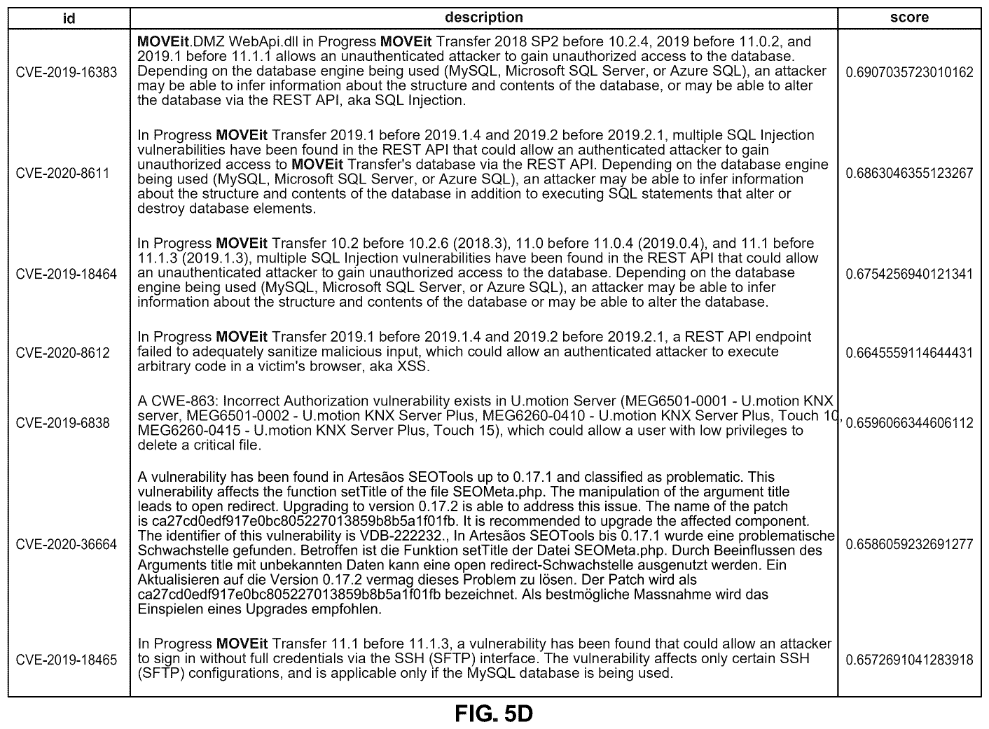

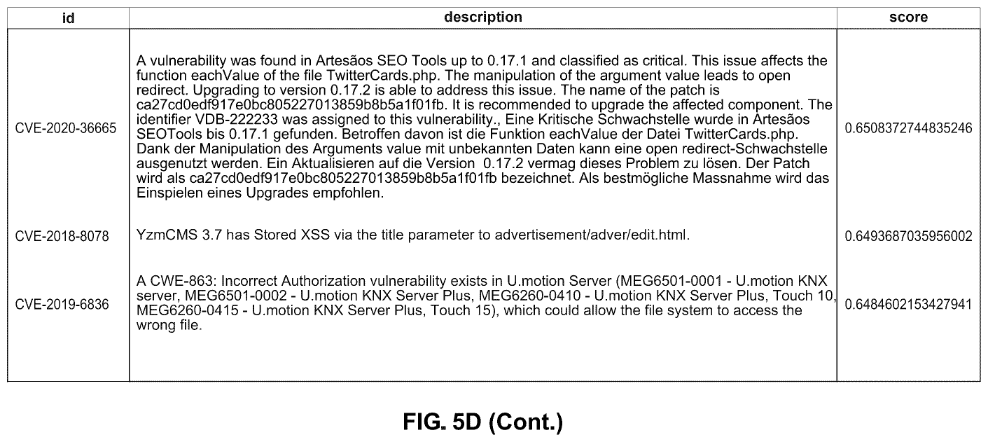

FIGS. 5A-D illustrate preliminary testing results of the experiment performed in this first case study in accordance with some embodiments.

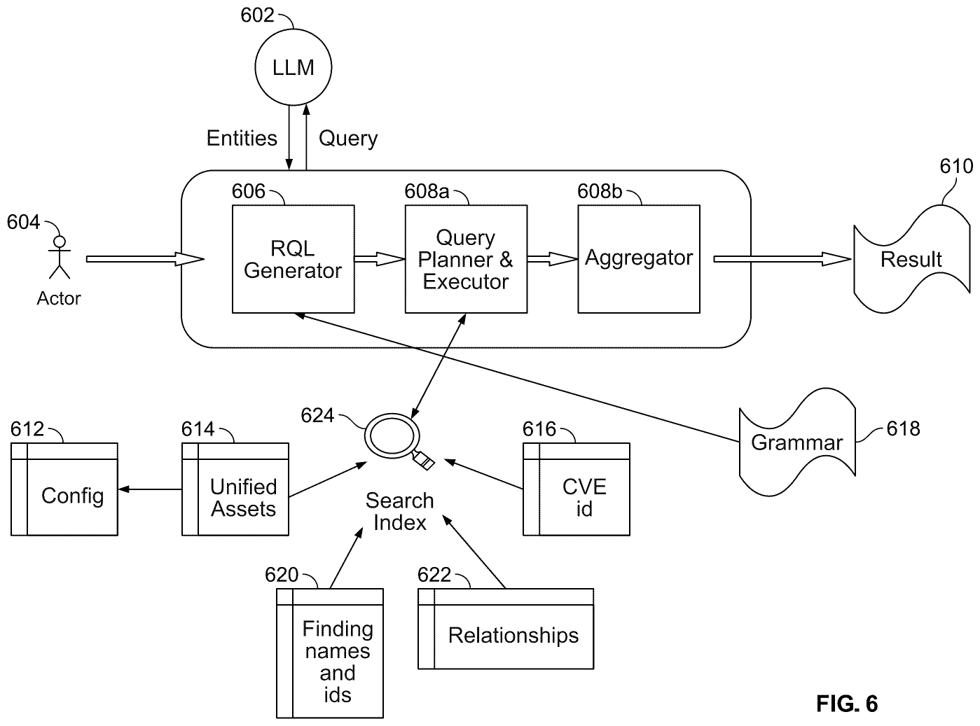

FIG. 6 illustrates an architecture and problem-solving diagram for generating an RQL in accordance with some embodiments.

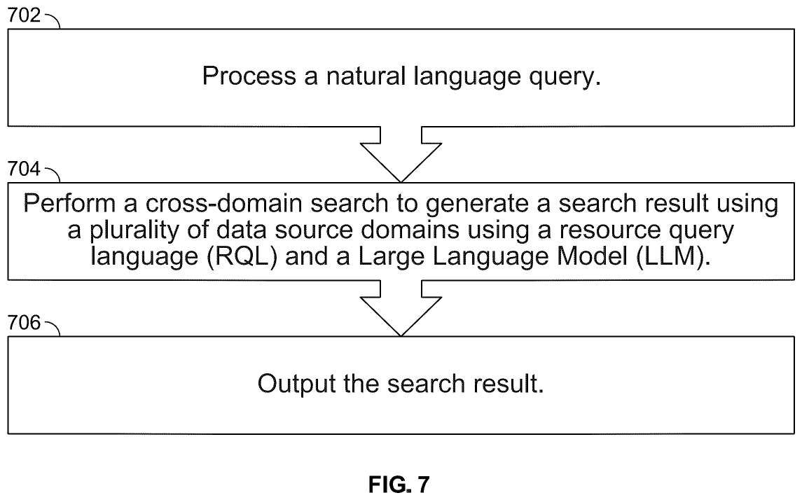

FIG. 7 is a flow diagram for AI-powered macros to process complex natural language processing (NLP) across domains in accordance with some embodiments.

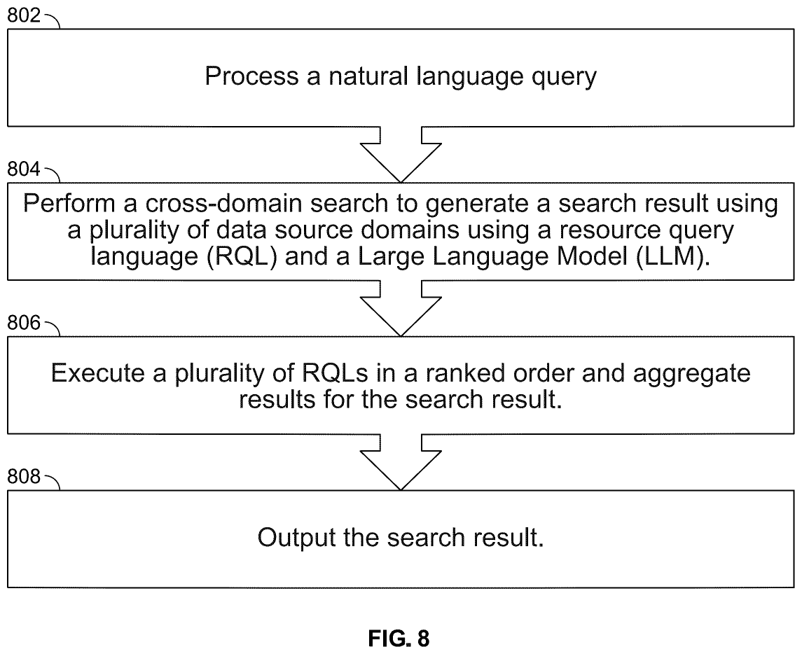

FIG. 8 is another flow diagram for AI-powered macros to process complex NLP across domains in accordance with some embodiments.

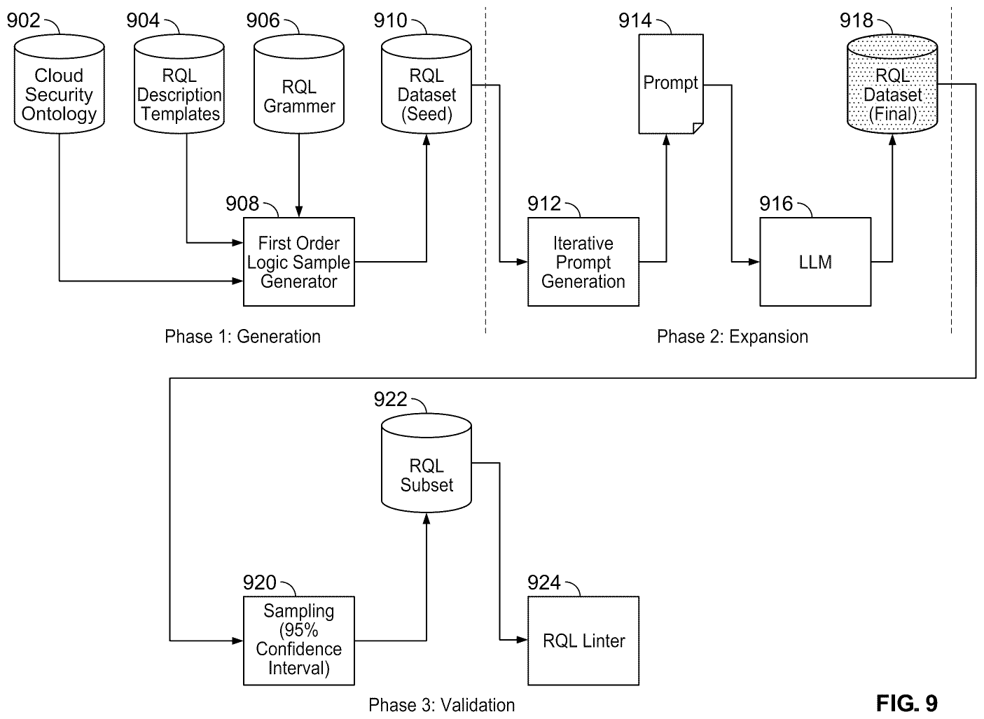

FIG. 9 illustrates an overall architecture and workflow diagram for grammar powered retrieval augmented generation for domain specific languages (DSLs) in accordance with some embodiments.

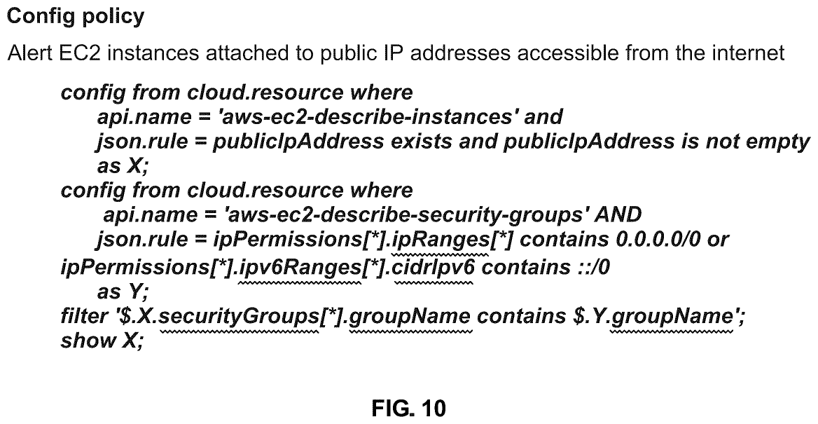

FIG. 10 is an example configuration policy for a cloud security service that is implemented in RQL in accordance with some embodiments.

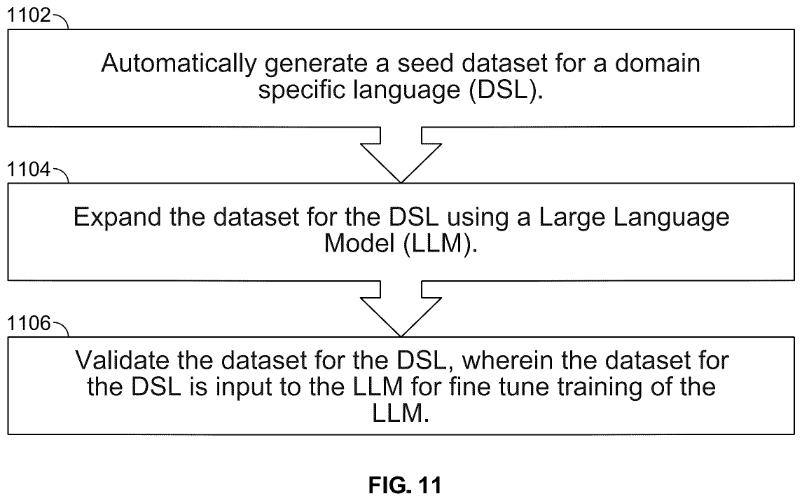

FIG. 11 is a flow diagram for grammar powered retrieval augmented generation for domain specific languages in accordance with some embodiments.

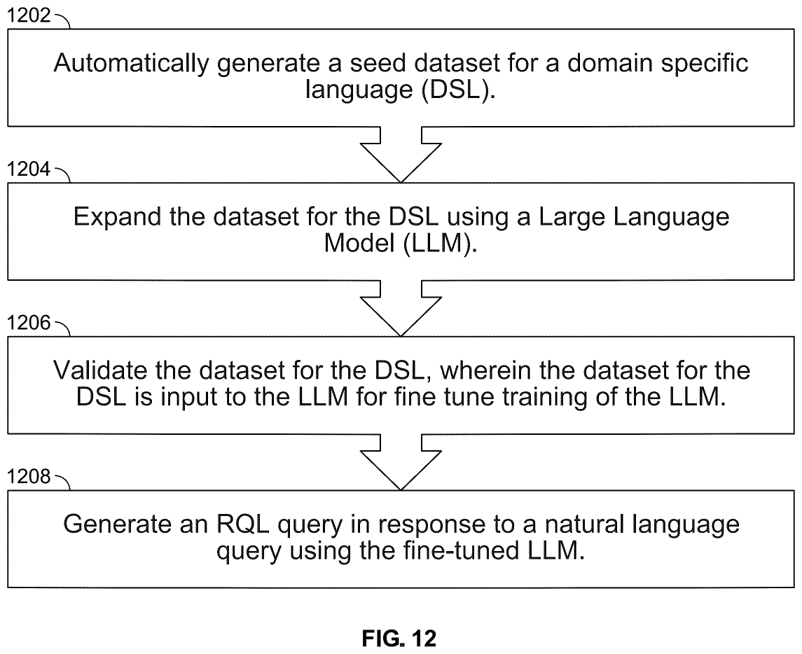

FIG. 12 is another flow diagram for grammar powered retrieval augmented generation for domain specific languages in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### Technical Challenges for Processing Queries Across Domains

Generally, a powerful feature of Artificial Intelligence (AI)/machine learning (ML) (e.g., generally also referred to herein as AI) is the ability to handle free-form text and build contextually relevant responses. In this context, AI also generally is herein to refer to the recent advances in generative pre-trained models using large-language models (LLM) and neural networks. AI has spurred significant activity in building modules that work collaboratively with the users and provide guidance to solving problems in a variety of applications.

Generally, LLMs can be implemented for various applications based on their training and tuning, such as generating text (e.g., text LLMs generally refer to LLMs specifically trained to handle text dialogs), generating code (e.g., code LLMs generally refer to LLMs trained on code such as Python, SQL, etc.), generating images, etc.

As will be further described below, the disclosed techniques are focused on applying AI to provide enhanced solutions in the security space. Specifically, the disclosed techniques apply various AI techniques to surface threats or breaches in a timely manner, which is of paramount importance for many security services/solutions.

Currently, the security space offers a range of tools to solve problems in Cloud Security Posture Management (CSPM) and Cloud Native Application Protection (CNAPP). However, the vast majority of these tools are specialized, and the user interfaces are designed to address a narrow spectrum of the domains. For example, there will be specialized security posture to find individual violations in Configuration, Network, Audit Events, Roles/Permissions, etc. To accomplish cross domain inferences, with the exception of join queries supported by Prisma® Cloud in Configuration (e.g., Prisma® Cloud is a cloud-based security service that is commercially available from Palo Alto Networks, headquartered in Santa Clara, CA, or this is similarly applicable to other commercially available cloud-based security solutions/services), results are pre-computed and cached in a consolidated resource called Assets. While searching with natural language, the user query is very likely to span multiple domains and predicates, unconstrained by the internal representations or implementations.

Traditional approaches using precomputed caches or customized user interfaces typically cannot handle the explosive combination of domains, partial orders, and predicates. Precomputations relate to annotating a global asset about findings or vulnerabilities seen in resources associated with the asset. For example, an EC2 Instance, an Amazon Cloud Resource, may be configured with a network interface and ports that are exposed to the Internet. The Internet exposure is determined by an independent policy engine that scans for violations periodically. Once a violation is detected, the policy engine generates an alert that is propagated to the asset via periodic polling. The policy violation is recorded on the asset with a finding called “INTERNET_EXPOSURE”. Assuming assets are updated in real time (e.g., generally there is a lag due to coordination between independent processes), the user will be able to retrieve responses to queries such as “Find me EC2 Instances with access to the Internet” based on the last finding snapshot received. Similarly, vulnerabilities are periodically scanned, and an independent process determines if a resource is vulnerable and creates a record on the asset.

Consider a user query that goes one step further, posed as “Find me EC2 Instances with access to the internet and tagged as financial-identifier.” This query cannot be fully answered by the precomputed caches as there is no knowledge about tags in the asset domain. Instead, the system has to discover resources that are tagged as “financial-identifier” and additionally contain the findings about Internet access. Furthermore, we could have a very large number of such predicates that cannot be processed unless we inspect multiple domains simultaneously. In general, if the precomputed cache contains a join between two cloud resources A and C, a search system cannot respond to a dynamic query inquiring about A and N. This example illustrates the limitations of the existing approaches to providing security insights with precomputed caches or customized user interfaces.

A popular approach in contemporary AI is to detect the intent of the text, before proceeding to templated query processing. The selected intent may lead us to a good response, if it fits within a single domain. If there is an error in the intent-detection, the proposed recovery is through “context repair.” Repairing a context is computationally expensive. The system has to know what facts to keep and what to forget before switching to another trail of thought. Hence, these approaches are time-consuming, error-prone, and unscalable. Early commitments to intents can veer down paths from which recovery becomes very difficult. Given that a single intent cannot justify a multi-domain search, the system could produce solutions that are only partial to the query addressed, leading often to dead ends and incomplete responses.

Thus, new and improved techniques are needed for processing complex queries across domains.

### Overview of Techniques for AI-Powered Macros to Process Complex NLP Queries Across Domains

Accordingly, new and improved techniques for AI-powered macros to process complex natural language processing (NLP) across domains are disclosed.

For example, various techniques are disclosed that facilitate an effective and efficient solution for gracefully handling multi-domain queries utilizing various Artificial Intelligence (AI)/machine learning (ML) techniques (e.g., generally also referred to herein as AI, such as generative pre-trained models using large-language models (LLM) and neural networks) as further described below.

In some embodiments, a system, a process, and/or a computer program product for AI-powered macros to process complex natural language processing (NLP) across domains includes processing a natural language query; performing a cross-domain search to generate a search result using a plurality of data source domains using a resource query language (RQL) and a Large Language Model (LLM); and outputting the search result (e.g., an output graph of assets in response to the natural language query).

For example, performing the cross-domain search to generate the search result using a plurality of data source domains can further include using a planner, executor, and aggregator to collect distinct results from each of the plurality of domains and/or further using an application programming interface (API).

In an example implementation, the plurality of data source domains includes a configuration data set, an Identity and Asset Management (IAM) data set, and a vulnerability data set.

In some embodiments, a system, a process, and/or a computer program product for AI-powered macros to process complex NLP across domains further includes performing the cross-domain search to generate the search result using a plurality of data source domains further includes executing a plurality of RQLs in a ranked order and aggregating results for the search result.

For example, the disclosed techniques for AI-powered macros to process complex NLP across domains can be applied to facilitate robust handling of ad hoc, mixed domain queries, such as will be further discussed below.

Moreover, the disclosed techniques for AI-powered macros to process complex NLP across domains provide for efficient resolution without major backtracking as further discussed below.

As such, the disclosed techniques for AI-powered macros to process complex NLP across domains can effectively and efficiently be applied to facilitate expanded, cross-domain searches as will also be further described below.

These and other aspects and embodiments for AI-powered macros to process complex NLP across domains will now be further described below.

### System Embodiments for AI-Powered Macros to Process Complex NLP Queries Across Domains

### AI-Powered Macros to Process Complex NLP Queries Across Domains

Various system embodiments for AI-powered macros to process complex natural language processing (NLP) across domains are disclosed.

FIG. 1 illustrates an overview of an architecture for AI-powered macros to process complex natural language processing (NLP) across domains in accordance with some embodiments. Specifically, a solution for AI-powered macros to process complex NLP across domains is described that can be effectively and efficiently provided for any environment that includes a mix of DSL (Domain Specific Language) and API (Application Programming Interface) to provide search responses. More specifically, FIG. 1 illustrates an example implementation of an architecture for applying AI-powered macros to process complex NLP across domains in a security computing context as will now be further described below.

Referring to FIG. 1, a user can find their configured EC2 instances with access to the Internet tagged “financial-identifier” as shown at 102. Specifically, the disclosed architecture facilitates an effective extraction of structural queries from text, using LLMs and Information Retrieval (IR).

A natural language translator 104 processes the user's query received at 102 to generate an intermediate representation as shown at 106. In this example implementation, the intermediate representation is in a JavaScript Object Notation (JSON) format (e.g., or another format can similarly be used for the intermediate representation). The intermediate representation is then provided as input to the planner/executor/aggregator component 108.

In this example implementation, the planner/executor/aggregator component 108 provides for the specification and implementation of an abstract planning language that dynamically constructs a plan, assembles the results, and seamlessly provides the response within the constructs of an existing presentation layer that can generate an output of the result as shown at output graph 116. Specifically, in this example implementation, a cloud security service (e.g., using the Prisma® Cloud security framework, which is a commercially available cloud security service available from Palo Alto Networks, Inc., headquartered in Santa Clara, CA) is used as a vehicle to present the disclosed techniques for applying AI-powered macros to process complex NLP across domains in a security computing context.

As also shown, the planner/executor/aggregator component 108 is in communication with a Resource Query Language (RQL) component 110. In this example implementation, the domain specific language (DSL) for the Prisma Cloud security framework is referred to as RQL. Specifically, RQL is available for the following domains (e.g., various mixed domains) of the security space: (1) configuration; (2) network; (3) audit events; (4) identity and access management (IAM); (5) cloud network security; (6) vulnerabilities; (7) assets; (8) findings; and/or various other domains of the security space can similarly be specified using RQL. As will also be apparent, these techniques can be similarly applied to other technology spaces, such as cloud computing, etc.

The domain of RQL is query processing. Generally, it entails defining a high-level language to express policies using vocabulary from, in this example implementation, the cloud security domain, building a valid query sentence by populating suggestions from various domain resources, generating an executable query against various data sources, filtering results against given criteria, and presenting the results for visualization, as will be further described herein.

As also shown, the planner/executor/aggregator component 108 is in communication with an application programming interface (API) component 112. In this example implementation, more than two hundred APIs are available to query data including the following examples: (1) alerts; (2) inventory; (3) compliance; and (4) reports, etc. Specifically, the various RQLs and APIs become the primitive building blocks upon which the multi-domain query language is based as will be further described below.

As such, the above-described architecture as shown in FIG. 1 can be used to automatically specify the intermediate representation for converting NLP to a structured query and to then build an AI planner to process the query by proper sequencing and assemblies of intermediate results from various data sources as shown at 114. The output can then be delivered within the constructs of an existing presentation layer, such as output graph 116. For example, the disclosed techniques can be implemented using the above-described architecture illustrated in FIG. 1 to provide an effective and efficient AI copilot solution for a cloud security service (e.g., Prisma Cloud AI Copilot).

FIG. 2 illustrates multi-domain query examples in accordance with some embodiments. Specifically, examples of multi-domain queries in a security service (e.g., the Prisma Cloud security service or another cloud security service) are shown in FIG. 2.

An example multi-domain query 202 is for a request to find assets of type EC2 instances with vulnerabilities attached to network interfaces that transferred more than 800k bytes in the last 24 hours. As such, this multi-domain query involves queries across the following distinct domains: finding, assets, and vulnerability data repositories.

An example multi-domain query 204 is for a request to find all EC2 assets with public IP and Internet access that are not running at this time. As such, this multi-domain query involves queries across the following distinct domains: finding, assets, and configuration data repositories.

An example multi-domain query 206 is for a request to find EC2 assets that have customer managed policy and have a high privileged role finding. As such, this multi-domain query involves queries across the following distinct domains: finding, assets, and IAM data repositories.

FIG. 3 illustrates a processing view for a multi-domain search architecture for AI-powered macros to process complex NLP across domains in accordance with some embodiments. In this example implementation, as similarly shown and described above with respect to FIG. 1, we begin with the assumption that most security vendors (e.g., including cloud-based security service vendors) offer a range of tools that either use a DSL (e.g., implemented using RQL 110 as shown in FIGS. 1 and 3) or an API (e.g., implemented using API 112 as shown in FIGS. 1 and 3) to enable retrieving relevant information (e.g., configuration information, network information, audit event information, cloud instances information, vulnerability information, etc.). In the context of Prisma Cloud, we have the following publicly documented DSL (e.g., publicly available at https://docs.prismacloud.io/en/classic/rql-reference/rql-reference/rql), which includes, for example, the following: (1) configuration information; (2) network information; and (3) audit event information.

For example, Prisma Cloud Resource Query Language (RQL) (e.g., implemented using RQL 110 as shown in FIGS. 1 and 3) is a powerful and flexible tool that helps users, such as a user 302, gain security and operational insights about their deployments in public cloud environments. Users can utilize RQL to perform configuration checks on resources deployed on different cloud platforms and to gain visibility and insights into user and network events. Users can also apply these security insights to create policy guardrails that secure their cloud environments.

In this example implementation, RQL is a structured query language that resembles Structured Query Language (SQL). RQL supports the following example types of queries: (1) Config—Use Config Query to search for the configuration of the cloud resources; (2) Event—Use Event Query to search and audit all the console and API access events in your cloud environment; (3) Network—Use Network Query to search real-time network events in your environment; and/or various other types of queries can be similarly supported using RQL.

As such, users can utilize RQL to find answers to fundamental questions that help them understand what is happening on their network. For example, users can find answers to the following types of questions: (1) does our enterprise have S3 buckets with encryption disabled; (2) does our enterprise have databases that are directly accessible from the Internet; (3) who uses a root account to manage day-to-day administrative activities on my network; (4) which cloud resources are missing critical patches that make them exploitable; etc.

As similarly described above, multiple APIs (112) are included in the architecture that provide responses about various domains, such as alerts, compliance, inventory, reports, etc.

However, converting natural language text queries directly to a specialized DSL poses significant technical challenges. Large-Language Models (LLMs) are largely trained on public repositories with an abundance of examples. For example, converting a piece of text to either Python code or SQL (Structured Query Language) is easier to accomplish with LLMs trained on a huge repository of time-tested examples on the web or GitHub.

But specialized DSLs, such as RQL, have limited presence on the web, making it more difficult for LLMs to do a robust translation for converting natural language text (NLP) queries to specialized DSLs, such as RQL. In the case of RQL, only the default policies are documented and available on the web. Hidden from the LLM are numerous custom policies with rich formulations that are proprietary. Also, the foundations of the DSLs are not easily available compared to relational languages, such as SQL, and programming languages, such as Python. As such, in this example implementation, a customized inference engine 108 (e.g., including planner, executor, and aggregator modules as similarly shown and described above with respect to FIG. 1) is provided to accomplish the translation for converting natural language text (NLP) queries to specialized DSLs, such as RQL.

Specifically, we address the above technical challenges by providing the following technical improvement to facilitate a robust translation for converting natural language text (NLP) queries to specialized DSLs, such as RQL. First, instead of having an LLM, such as shown at 320, go directly from text to RQL, we specify an intermediate format that is easily reachable by the LLMs, in quality and precision, such as shown at 322. Following this, we also define a robust transformation procedure to convert the intermediate representation as shown at 106 to the final DSL format (e.g., RQL).

As shown in FIG. 3, the process to handle multi-domain queries involves the following modules: (1) Natural Language Translator 104 that includes the following modules: an entity extractor and an intermediate representation generator 106 as shown; and (2) an Inference Engine 108 that includes the following modules: a planner, an executor, and an aggregator. Each of these sub-components will be further described below.

Referring to the modules of the natural language translator (104), an entity extractor is provided as a module of the natural language translator. Using its extensive knowledge from the web, the LLM performs entity recognition and generates a structured JSON representation equivalent to the input query. To accomplish this, suitable prompts and instructions using the lexicon in our application are generated for training the LLM (e.g., single shot or few shot training of the LLM can be utilized in this example implementation).

An example prompt is provided below.

You are a computer security expert. If I give a text query, you will be able to recognize the various entities. The entities are: cloudType, cloudResource, findings, vulnerabilities, and rules. Give the output in JSON format.

```
Input Text:
Find me EC2 instances with access to the internet tagged
″financial-identifier”.
Output JSON:
{
  ″cloudResource″: ″EC2 Instances″,
  ″cloudType″: ″AWS″,
  ″finding″: ″internet access″,
    ″rules″: {
      ″tag″: ″financial-identifier″
  }
}
```

Note that the LLM automatically deduced the cloudType with its general knowledge about cloud security and associated documentation about Amazon Web Services (AWS).

FIG. 4 illustrates an example entity extraction in accordance with some embodiments. The above-described entity extractor module of the natural language translator (104) can be used to perform this example entity extraction.

Referring again to the modules of the natural language translator (104) as shown in FIG. 3, an intermediate representation generator (106) is provided as a module of the natural language translator. Using a combination of semantic searches (e.g., using LLM embeddings) and retrieval augmentation (e.g., classical information retrieval methods related to auto-indexing with TF (Term Frequency) and IDF (Inverse Document Frequency)), the values of the fields are mapped to strings that are present in the cloud resources. For example: “internet access” under the domain of Findings will retrieve “INTERNET_EXPOSURE” as the best match and “EC2 Instance” will map to a known API name in the repository aws-ec2-describe-instances. The extracted “rules” field will transfer to a JSON rule condition as documented in the Prisma Cloud RQL Language.

```
{
  “asset”: {
    “type”: “EC2 Instance”,
    “finding”: [“INTERNET_EXPOSURE”],
    “with” : {
      “config”: {
        “api.name”:“aws-ec2-describe-instances”,
        “json.rule”: “tag.key[*] contains financial-identifier”
      }
    }
  }
}
```

Note that such a language structure does not exist in Prisma Cloud. It is simply an abstraction to compute the results of a multi-domain search. The language structures supported and documented in Prisma Cloud are siloed, specific to each domain. As such, we are creating a pseudo query across domains without any prior grammar or language definition. Nevertheless, this pseudo query creates a cross domain query structure that can be parsed and processed by the planning module as will now be described below.

Referring to the modules of the inference engine (108), a planner is provided as a module of the inference engine. The planner is generated from generic abstractions, for performing the following: (1) selecting the domain query to execute; (2) executing the domain query and retrieving the JSON output; (3) joining or filtering results based on domain specific identifiers; (4) propagating results to relevant parts of the query plan; and (5) applying pagination (optional).

In an example implementation, a Backus normal form (BNF) definition is provided for the planner. The planning language for this application can work with a very generic structure and a set of operators covering conjunctions, disjunctions, and negations, which allows for calling individual DSL domains, obtaining the result in a JSON format, and applying aggregations (e.g., joins and filters). In addition, the language parser can maintain a hierarchy of processing operations to complete before a final result is generated.

Below is an example BNF definition.
Query:=DSL_Query|API_Query
DSL_Query:=domainQuery (AND WITH:(domainQuery))
DSL_Query:=domainQuery AND domainQuery
DSL_Query:=domainQuery OR domainQuery
DSL_Query:=NOT domainQuery
API_Query:=apiQuery
domainQuery:=assetQuery|configQuery|networkQuery|eventQuery|apiQuery
apiQuery:=alertsApiQuery|complianceApiQuery|reports ApiQuery|
inventory ApiQuery

In this example implementation, by default, the planner assumes the output format of the parent domain query. Hence, for the query presented in FIG. 3, the output is an Asset graph (e.g., shown as output graph 116). As another example, for a cross domain query with network and config domains, the output would be a network graph.

To assemble the overall result, the planner executes the nested tasks and propagates the results to the parent query and assembles based on consistent domain identifiers (e.g., it is typically the Resource Identifier). Extremely large subquery results can be automatically paginated (e.g., as an optional stage of processing).

Also, DSL wrappers can be created for all the domain APIs. For example, this makes the maintenance cleaner, separating the data access layer from the domain specific predicates.

For saving a search result, all individual domains have the ability to save a search as a DSL (e.g., RQL). In this example implementation, once a text query is converted by the disclosed system/process/computer program product, the equivalent DSL query will be saved.

In order to generate a multi-domain policy, individual domain policies are created first. These policy pointers can be added to the output as a global policy.

Various use cases for AI-powered macros to process complex NLP across domains will now be described below.

### Experiments and Use Cases for AI-Powered Macros to Process Complex NLP Queries Across Domains

As similarly discussed above, the disclosed techniques can be applied to various use cases for AI-powered macros to process complex NLP queries across domains in a security context, such as will now be described below.

For example, there currently exists a paucity of realistic training instances for asset RQL queries. As such, synthetic generation of training data can be utilized as well as test instances using the underlying grammar. Selecting a probability distribution is another technical challenge in synthetic test data generation.

Generally, LLMs are opaque boxes. For example, it can be difficult to determine the “loss of matches” in an LLM-based approach to solving the above-described problems for processing complex NLP queries across domains, such as in a security context. Specifically, in the context of either vulnerabilities or findings, losing matches could pose significant issues for users of such a solution (e.g., posing increased security risks for their enterprise computing environments).

As such, while semantic search provides a vast net of possible contexts to capture, the security domain queries can often be short sentences that likely include high-value (e.g., high entropy) keywords. As a result, with short queries working towards context building, LLM-based suggestions are likely to be less accurate due to a wider context in which the LLMs are trained. The repositories needed to address the queries in the security domain could be specialized, narrowed and not necessarily indexed by an LLM.

Even if a domain repository, such as Mitre data (e.g., publicly available sources of security/attack related data, which is publicly available at https://attack.mitre.org/datasources/), is indexed by an LLM, it may not be current and is unlikely to have seen all possible queries that may be targeted at the index.

In a pure AI/ML approach, both “few-shot learning” and “fine-tuning” are trial-and-error AI/ML training approaches (e.g., for LLMs) that require multiple trials or generation/accumulation of a significant number of training instances. Furthermore, the resulting AI/ML models would likely be sensitive to domain data changes requiring continuous adaptation/updating. The adaptation/updating process can add to maintenance costs associated with the solution for processing complex NLP queries across domains, such as in a security context.

LLMs are effective AI/ML tools for entity recognition, given their built-in Information Extraction modules (e.g., as similarly discussed above with respect to FIG. 4). As such, the disclosed techniques utilize the entity recognition features of an LLM for providing a solution for processing complex NLP queries across domains (e.g., generating the building blocks across the different attributes in the RQL using a combination of information retrieval (IR) and AI/ML, such as further described below).

In this experiment and example uses cases further described below, the disclosed techniques using IR and AI/ML are applied for an asset RQL.

The design of the experiments for using IR and AI/ML applied for an asset RQL will now be described.

We first performed a range of tests and compared the retrieval quality between AI/ML and IR using the following: (1) single keyword searches (e.g., search terms: log4j or log4J2, MOVEit); (2) phrasal searches; (3) full sentences after the IR index is equipped with stop words, stems, and synonyms (e.g., a typical use case is: “What are my assets with log4j vulnerabilities?”; utilization of term frequencies (Term and Document) in boosting keywords at query time; and utilization of facets to get insights into various distributions, thereby selecting the appropriate words in a prompt).

The Mitre vulnerability database has been used in this AI CoPilot case study to demonstrate the effective building of RQL queries from the natural language inputs. The Mitre JSON data is rich, offering a multitude of fields on which we can build predicates. In this example, the CVE ID and the associated description were used in the AI CoPilot index.

Generation of the IR index will now be described. The IR index was generated using multiple cores (e.g., shards). For the initial investigation in this experiment, we focused on the vulnerabilities. Similarly, the Findings, Assets, and Relationships can be added to their respective cores.

Approximately 71K documents between the years 2017-2023 from the Mitre CVE JSON 5.0 data were inserted into the IR index. All JSON paths are fully enumerated and stored for individual search within a path.

In seeking accurate matches, the preliminary index was based on word boundaries. Various IR enhancements can also be utilized, such as stemming, stop words, phrases, synonyms, etc.

Generation of the AI index will now be described. The AI index was built by generating Gecko embeddings (e.g., to convert textual data into numerical vectors to capture the semantic meaning and context of the words to facilitate processing by AI/ML techniques) for each CVE Description and the following fields are stored for processing: (1) ID; (2) description; and (3) embedding vector.

For initial research, we performed a full table scan of the entire set of embeddings to determine the top ten matches, ranked in descending order of similarity score.

To expedite finding matches in the embeddings store, improvements such as clustering or organizing the various embeddings by distance were evaluated.

FIGS. 5A-D illustrate preliminary testing results of the experiment performed in this first case study in accordance with some embodiments. Specifically, the preliminary testing results of IR versus AI will now be described for this experiment.

The below table summarizes the accuracy of the results obtained for single keyword searches.

TABLE 1

Method

| Keyword Test | IR | AI |
|---|---|---|
| log4j or log4J2 | 7/7 (100%) | 4/7 (57%) |
| MOVEit | 7/7 (100%) | 4/7 (57%) |

LLM-based (AI) approach is still desired for entity recognition in a user query. For extracting the parameter values in short text queries containing essential keywords (i.e., log4j, MOVEit, etc.), the LLM-based (AI) search has an accuracy rate of 0.4 compared to 1.0 using standard information retrieval (IR) techniques. In essence, the AI approach is missing some vulnerability records. It is possible we could do better in the AI search by modifying the parameters in Gecko or updating to later versions.

These preliminary tests in this example experiment and other experiments based on phrasal searches can determine how to obtain maximum precision (e.g., no loss of vital records) in the disclosed AI CoPilot/AI-powered macros for processing complex NLP across domains.

As such, the observations from the initial experiments provide a path for a combined approach using the Grammar, IR, and AI approaches to crafting the Asset RQL.

FIG. 6 illustrates an architecture and problem-solving diagram for generating an RQL in accordance with some embodiments.

Specifically, in an example implementation, the Asset RQL grammar is used as the foundation for interpreting and transforming user queries to RQL, shown as a final RQL as shown at 610 in FIG. 6. For example, a customized vector space for the individual parameters (e.g., configuration information 612 and unified assets information (UAI) 614, findings such as file names and IDs 620, relationships 622, vulnerabilities such as CVE IDs 616, etc., can be provided as input to a search index 624, as well as a grammar 618 (e.g., a Hyperion grammar or other grammar can similarly be used as input to the RQL generator) can be utilized to provide enhanced accuracy for an RQL generator 606 that generates RQLs for input to evaluation and ranking using Query Planner and Executor 608a and Aggregator 608b to facilitate generating a final RQL 610.

More specifically, in this example implementation, the samples include unified assets information (UAI) (614), findings (e.g., Cloud Security Posture Management (CSPM), Identity and Asset Management (IAM), CAN, etc.), vulnerabilities (e.g., within asset RQL, including three parameters for vulnerabilities: CVE ID, Severity, and CVSS score), and relationships (e.g., a certain/threshold percentage of assets should be connected).

Further, the IR approach can help to suggest a limited lexicon specific to the use case, such as vulnerabilities in the prompts (e.g., for the LLM). The application scope begins with individual tests for vulnerabilities, findings, and then progresses to Asset related parameters, such as Asset Type, Asset Class, and Relationships. Asset configurations can be added to the goals, allowing us to process NLP queries that refer to config parameters, such as “tags” or predicates over the JSON paths.

In the AI approach using an external LLM as shown at 602 in FIG. 6, the statistical properties of words and associations are exhibited via the embeddings. The embeddings do not provide a glimpse into the individual words and co-occurrences until a semantic match is executed.

Further, the IR world presents an opportunity to statically examine the various word/phrase distributions, paving the way for enriching the IR search or to utilize the statistical properties in building more effective prompts.

As such, the above-described techniques of utilizing an IR in combination with an AI using LLMs can facilitate the automated generation of a customized lexicon for each usage context (e.g., Findings, Vulnerabilities, etc.). This will help to optimize the embedding vectors in the disclosed AI LLM techniques as described herein.

In addition, as also shown in FIG. 6, the inclusion of asset configurations and relationships is provided. As such, concurrent searches can be executed on other repositories, such as asset repositories to integrate relevant information to a given query received by a user, such as shown at 604.

The statistical properties extracted from the search repositories, frequencies, and facets also provide for executing high-precision searches in the IR index.

By analyzing a large number of transactions, we can find the best way to combine the search results returned by both IR and AI approaches to maximize precision and minimize latencies.

In this example implementation, an LLM-based entity recognition can be provided using, for example, Chat Bison to extract the entities in any given user query, such as illustrated in FIG. 4 as described above. The entities can be constrained using a customized lexicon from the IR module and output in JSON format.

Below is an example context for prompting the LLM for this example implementation.

Prompt:

You are an expert entity recognizer. The primary entities are Findings, Vulnerabilities, Assets, and Relationships. For any given user text, provide the extracted entities in a JSON structure.

Specifically, an example entity extraction using the disclosed techniques is shown in FIG. 4 as similarly described above.

Additional example use cases for testing are provided below.

### Example Use Case 1:

```
  Show me the assets with log4j vulnerability
AI:
  {
  “vulnerabilities”: “log4j”,
  “asset”: “all”,
  “cloudType”: “all”
  }
```

### Example Use Case 2:

```
  Which EC2 instances have unrestricted access from the Internet, are
  talking to Backdoor hosts, and have vulnerabilities of high severity or
  greater?
AI:
  }
  “findings”: “unrestricted access from the internet”,
  “vulnerabilities”: “high severity or greater”,
  “asset”: “EC2 instances”,
  “relationships”: “talks to Backdoor hosts”
  }
```

### Example Search Indices Implementation

The embeddings used by the AI CoPilot reside in SingleStore, or another commercially/publicly available (real-time) data warehouse can similarly be used. Specifically, SingleStore is configured to execute the Cosine Similarity matches directly on the data (e.g., the embedding is a column value in a DB table) through a full table scan to get the top N (as required) hits.

In this example implementation, the embeddings can be stored in a Lucene index or another commercially/publicly available search index can similarly be used. Further, the research embeddings can be organized in clusters for fast processing.

Below is an example set of findings based on the above-described experiment. Specifically, the findings were collected using asset class and finding types. The rationale is to use higher-level constructs in the taxonomy of types, thereby covering samples across many assets and finding types. The vulnerabilities appeared in only 4/982 asset types across all clouds (e.g., 2 in AWS, 1 in Azure, and 1 in Google Cloud). Within those assets there is a huge collection of vulnerabilities. The same lopsided distribution is seen in all three stacks: host0, host1 and host2. The findings are spread over many asset classes. Vulnerabilities are limited to very few asset classes but appear in large counts within those classes. In this experiment, rank by latencies was as follows: host2 (fastest), host0, host1 (slowest) (e.g., app4 appears to have the best data distribution for deriving training data).

A summary of these experiment findings is provided below.

| | finding | | |
|---|---|---|---|
| | type | rank by size of | |
| host | count | (Asset Class, Finding Type) | comments |
| host0 | 12/70 | Compute_HIGH_PRIVILEGED_ROLE | Only 1 asset class |
| | | Compute_INTERNET_EXPOSURE | |
| | | Compute_PRIVILEGE_ESCALATION | |
| | | Compute_CROSS_ACCOUNT_TRUST | |
| | | Compute_UNAUTHORIZED_ACCESS | |
| | | Compute_MISCONFIGURATION | |
| | | Compute_KEYS_AND_SECRETS | |
| | | Compute_UNENCRYPTED_DATA | |
| | | Compute_RECONNAISSANCE | |
| | | Compute_INITIAL_ACCESS | |
| | | Compute_DEFENSE_EVASION | |
| | | Compute_RESOURCE_HIJACKING | |
| host1 | 45/217 | Security_PRIVILEGE_ESCALATION | Six types of asset classes |
| | | Compute_PRIVILEGE_ESCALATION | 20% coverage across all |
| | | Compute_UNUSED_PRIVILEGES | asset classes and finding |
| | | Other_HIGH_PRIVILEGED_ROLE | types |
| | | Compute_CROSS_ACCOUNT_TRUST | |
| | | Compute_INTERNET_EXPOSURE | |
| | | Database_MISCONFIGURATION | |
| | | Other_PRIVILEGE_ESCALATION | |
| | | Other_MISCONFIGURATION | |
| | | Network_MISCONFIGURATION | |
| | | Compute_HIGH_PRIVILEGED_ROLE | |
| | | Storage_INTERNET_EXPOSURE | |
| | | Security_HIGH_PRIVILEGED_ROLE | |
| | | Storage_MISCONFIGURATION | |
| | | Security_MISCONFIGURATION | |
| | | Security_KEYS_AND_SECRETS | |
| | | Security_WEAK_PASSWORD | |
| | | Compute_UNAUTHORIZED_ACCESS | |
| | | Other_UNAUTHORIZED_ACCESS | |
| | | Security_UNAUTHORIZED_ACCESS | |
| | | Security_UNUSED_PRIVILEGES | |
| | | Compute_MISCONFIGURATION | |
| | | Security_USER_ANOMALY | |
| | | Other_UNENCRYPTED_DATA | |
| | | Other_CROSS_ACCOUNT_TRUST | |
| | | Storage_PRIVILEGE_ESCALATION | |
| | | Compute_UNENCRYPTED_DATA | |
| | | Compute_KEYS_AND_SECRETS | |
| | | Network_INTERNET_EXPOSURE | |
| | | Database_UNENCRYPTED_DATA | |
| | | Security_CROSS_ACCOUNT_TRUST | |
| | | Storage_UNENCRYPTED_DATA | |
| | | Network_UNENCRYPTED_DATA | |
| | | Security_MFA | |
| | | Storage_UNAUTHORIZED_ACCESS | |
| | | Security_UNENCRYPTED_DATA | |
| | | Storage_MFA | |
| | | Other_INTERNET_EXPOSURE | |
| | | Compute_RECONNAISSANCE | |
| | | Storage_CROSS_ACCOUNT_TRUST | |
| | | Database_PRIVILEGE_ESCALATION | |
| | | Other_UNUSED_PRIVILEGES | |
| | | Database_INTERNET_EXPOSURE | |
| | | Storage_UNUSED_PRIVILEGES | |
| | | Compute_DEFENSE_EVASION | |
| host2 | 86/217 | Compute_INTERNET_EXPOSURE | 7 asset classes |
| | | Compute_PRIVILEGE_ESCALATION | 39% coverage across all |
| | | Security_PRIVILEGE_ESCALATION | asset classes and finding |
| | | Other_MISCONFIGURATION | types |
| | | Database_MISCONFIGURATION | |
| | | Database_INTERNET_EXPOSURE | |
| | | Network_MISCONFIGURATION | |
| | | Security_MISCONFIGURATION | |
| | | Other_PRIVILEGE_ESCALATION | |
| | | Compute_HIGH_PRIVILEGED_ROLE | |
| | | Storage_INTERNET_EXPOSURE | |
| | | Security_HIGH_PRIVILEGED_ROLE | |
| | | Storage_MISCONFIGURATION | |
| | | Security_KEYS_AND_SECRETS | |
| | | Security_WEAK_PASSWORD | |
| | | Compute_UNAUTHORIZED_ACCESS | |
| | | Other_UNAUTHORIZED_ACCESS | |
| | | Storage_UNAUTHORIZED_ACCESS | |
| | | Security_UNUSED_PRIVILEGES | |
| | | Compute_INITIAL_ACCESS | |
| | | Security_USER_ANOMALY | |
| | | Compute_UNUSED_PRIVILEGES | |
| | | Storage_PRIVILEGE_ESCALATION | |
| | | Storage_MFA | |
| | | Other_UNENCRYPTED_DATA | |
| | | Other_CROSS_ACCOUNT_TRUST | |
| | | Compute_MISCONFIGURATION | |
| | | Compute_UNENCRYPTED_DATA | |
| | | Network_INTERNET_EXPOSURE | |
| | | Compute_KEYS_AND_SECRETS | |
| | | Security_UNAUTHORIZED_ACCESS | |
| | | Compute_CROSS_ACCOUNT_TRUST | |
| | | Security_CROSS_ACCOUNT_TRUST | |
| | | Storage_UNENCRYPTED_DATA | |
| | | Database_UNENCRYPTED_DATA | |
| | | Compute_RECONNAISSANCE | |
| | | Security_UNENCRYPTED_DATA | |
| | | Network_UNENCRYPTED_DATA | |
| | | Security_MFA | |
| | | Other_HIGH_PRIVILEGED_ROLE | |
| | | Storage_CROSS_ACCOUNT_TRUST | |
| | | Database_PRIVILEGE_ESCALATION | |
| | | Compute_DEFENSE_EVASION | |
| | | Other_INTERNET_EXPOSURE | |
| | | Other_UNUSED_PRIVILEGES | |
| | | Security_RESOURCE_HIJACKING | |
| | | Network_UNUSED_PRIVILEGES | |
| | | Network_PRIVILEGE_ESCALATION | |
| | | Storage_UNUSED_PRIVILEGES | |
| | | Compute_RESOURCE_HIJACKING | |
| | | Delivery_COMMAND_AND_CONTROL | |
| | | Delivery_HIGH_PRIVILEGED_ROLE | |
| | | Delivery_PRIVILEGE_ESCALATION | |
| | | Delivery_CROSS_ACCOUNT_TRUST | |
| | | Delivery_UNAUTHORIZED_ACCESS | |
| | | Delivery_CREDENTIAL_ACCESS | |
| | | Delivery_DATA_EXFILTRATION | |
| | | Delivery_RESOURCE_HIJACKING | |
| | | Delivery_INTERNET_EXPOSURE | |
| | | Delivery_KEYS_AND_SECRETS | |
| | | Delivery_LATERAL_MOVEMENT | |
| | | Delivery_UNUSED_PRIVILEGES | |
| | | Delivery_MISCONFIGURATION | |
| | | Delivery_UNENCRYPTED_DATA | |
| | | Delivery_DEFENSE_EVASION | |
| | | Delivery_INITIAL_ACCESS | |
| | | Delivery_RECONNAISSANCE | |
| | | Delivery_WEAK_PASSWORD | |
| | | Delivery_USER_ANOMALY | |
| | | Delivery_DISCOVERY | |
| | | Delivery_MALWARE | |
| | | Security_COMMAND_AND_CONTROL | |
| | | Delivery_MFA | |
| | | Security_CREDENTIAL_ACCESS | |
| | | Security_DATA_EXFILTRATION | |
| | | Security_INTERNET_EXPOSURE | |
| | | Security_LATERAL_MOVEMENT | |
| | | Security_DEFENSE_EVASION | |
| | | Security_INITIAL_ACCESS | |
| | | Security_RECONNAISSANCE | |
| | | Kubernetes_HIGH_PRIVILEGED_ROLE | |
| | | Kubernetes_PRIVILEGE_ESCALATION | |
| | | Kubernetes_COMMAND_AND_CONTROL | |
| | | Kubernetes_CROSS_ACCOUNT_TRUST | |
| | | Kubernetes_UNAUTHORIZED_ACCESS | |
| | | Kubernetes_RESOURCE_HIJACKING | |

Referring to FIG. 6, RQL Generator 606 can be implemented using the following processing operations (e.g., for an asset RQL generator). Specifically, in this example implementation, entities are first extracted in JSON formation.

Second, the JSON data is converted to a generic asset query.

Third, searches using Information Retrieval (IR) are performed, for example, implemented using listeners to handle the search in IR (e.g., for vulnerabilities, all IDs for the matching text can be searched and collected; for findings, all the finding types for a given text can be searched and collected; for relationships, edges with a source and sink can be searched and collected; etc.).

Fourth, if an asset type=ALL, the generic template for RQL can be provided as follows: (1) asset where asset.class IN ( . . . ) and finding.name IN ( . . . ) and with (vuln where id IN ( . . . )); and (2) asset where asset.type IN ( . . . ) and finding.name IN ( . . . ) and with (vuln where id IN ( . . . )). In some cases, to reduce our dependency on RQL processing and unforeseen errors, internal indices can be used to discover asset IDs. Hence, the template for RQL resembles the following: asset where asset.id IN ( . . . ) and finding.name IN ( . . . ) and with: (vuln where id IN ( . . .

Fifth, the available RQLs are then ranked.

Sixth, the ranked RQLs are then executed in ranked order. For example, in some cases, the candidate sets can be reduced by executing the most generic form of RQL.

The following example asset RQL covers all asset types and searches all CVE IDs for log4j:

```
                1. asset where asset.type IN (
                2. ‘aws-acm-describe-certificate’,
                3. ‘aws-describe-account-attributes’,
                4. ‘aws-describe-auto-scaling-groups’,
                5. ‘aws-ec2-autoscaling-launch-configuration’,
                6. ‘aws-elasticbeanstalk-configuration-settings’,
                7. ‘aws-elasticbeanstalk-environment’,
                8. ‘aws-elbv2-target-group’,
                9. ‘aws-elbv2-target-health’,
                10. ‘aws-account-management-alternate-contact’,
                11. ‘aws-elb-describe-load-balancers’,
                12. ‘aws-code-artifact-domain’,
                13. ‘aws-cloudhsm-cluster’,
                14. ‘aws-cloud9-environment’,
                15. ‘aws-dms-endpoint’,
                16. ‘aws-vpc-nat-gateway’,
                17. ‘aws-ec2-describe-network-acls’,
                18. ‘aws-ec2-describe-network-interfaces’,
                19. ‘aws-ec2-describe-security-groups’,
                20. ‘aws-ec2-describe-subnets’,
                21. ‘aws-ec2-traffic-mirroring’,
                22. ‘aws-vpc-transit-gateway’,
                23. ‘aws-vpc-transit-gateway-attachment’,
                24. ‘aws-vpc-transit-gateway-route-table’,
                25. ‘aws-ec2-describe-vpcs’,
                26. ‘aws-vpc-dhcp-options’,
                27. ‘aws-ec2-describe-instances’,
                28. ‘aws-ec2-classic-instance’ )
                29. AND with : (vuln where id IN (
                30. ‘CVE-2021-44228’,
                31. ‘CVE-2021-44530’,
                32. ‘CVE-2017-5645’,
                33. ‘CVE-2019-17531’,
                34. ‘CVE-2021-44832’,
                35. ‘CVE-2019-17571’,
                36. ‘CVE-2021-9488’))
        Result:
{
  “graphs”: [
    {
      “graph”: {
        “nodes”: {
          “CVE-2019-17571”: {
            “label”: “CVE-2019-17571”,
            “type”: “Vulnerability”,
            “metadata”: {
              “severity”: “critical”,
              “score”: 9.8,
              “patchable”: true,
              “published”: 1576862100000
            }
          },
          “8c9e2bf194a8f08d89b9a26c59014fe8”: {
            “label”: “ubuntu18-jira”,
            “type”: “PrimaryAsset”,
            “metadata”: {
              “externalAssetId”: “i-075688f1c9d8f5d06”,
              “assetType”: “EC2 Instance”,
              “assetCategory”: “VM Instance”,
              “apiId”: “16”,
              “accountId”: “767399230204”,
              “findingCount”: 19,
              “lastModifiedAt”: 1693145412789
            }
          }
        },
        “edges”: [
          {
            “source”: “b928ce51ff418f08d998ab992a806c4e”,
            “target”: “CVE-2019-17571”,
            “directed”: true,
            “relation”: “CONTAINS”
          }
        ]
      }
    }
  ],
  “resultMetadata”: {
    “searchId”: “6e837834-24dd-4fe1-8b07-1bcc19604665”,
    “cloudType”: “aws”,
    “convertedQuery”: “asset where asset.type IN ( ‘aws-acm-describe-certificate’, ‘aws-describe-
account-attributes’, ‘aws-describe-auto-scaling-groups’, ‘aws-ec2-autoscaling-launch-
configuration’, ‘aws-elasticbeanstalk-configuration-settings’, ‘aws-elasticbeanstalk-environment’,
‘aws-elbv2-target-group’, ‘aws-elbv2-target-health’, ‘aws-account-management-alternate-contact’,
‘aws-elb-describe-load-balancers’, ‘aws-code-artifact-domain’, ‘aws-cloudhsm-cluster’, ‘aws-
cloud9-environment’, ‘aws-dms-endpoint’, ‘aws-vpc-nat-gateway’, ‘aws-ec2-describe-network-
acls’, ‘aws-ec2-describe-network-interfaces’, ‘aws-ec2-describe-security-groups’, ‘aws-ec2-
describe-subnets’, ‘aws-ec2-traffic-mirroring’, ‘aws-vpc-transit-gateway’, ‘aws-vpc-transit-
gateway-attachment’, ‘aws-vpc-transit-gateway-route-table’, ‘aws-ec2-describe-vpcs’, ‘aws-vpc-
dhcp-options’, ‘aws-ec2-describe-instances’, ‘aws-ec2-classic-instance’ ) AND with : (vuln where
id IN (‘CVE-2021-44228’,’CVE-2021-44530’,’CVE-2017-5645’,’CVE-2019-17531’,‘CVE-2021-
44832’,‘CVE-2019-17571’,’CVE-2021-9488’))”,
“responseTimeInMs”: 334
  }
}
```

Seventh, the RQL generator may or may not be final. It could be an intermediate solution that gets refined by the LLM (e.g., fine-tuned LLM, implemented as a generative pre-trained (GPT) model, used by the CoPilot).

Referring to FIG. 6, RQL Generator 606 can be implemented using the following processing operations (e.g., for a configuration (config) RQL generator). Specifically, in this example implementation, entities are first extracted in JSON formation.

Second, the JSON data is converted to a generic config query template. Specifically, by applying the JSON on the parse tree, we can determine the resulting template to use. JSON rules would follow a separate template. The entity extractor can isolate the rule specific parts and the parameter portions of the RQL.

Third, searches using Information Retrieval (IR) are performed, for example, implemented using listeners to handle search in IR (e.g., to populate the various parameters in the config RQL template).

Fourth, the available RQLs are ranked.

Fifth, the ranked RQLs are then executed in ranked order. For example, in some cases, the candidate sets can be reduced by executing the most generic form of RQL.

### Example Unit Tests

Below are example unit tests for cross domain search. Each test includes the pseudo cross domain query and the expected output asset RQL.

### Unit Test Case 1:

```
// Case: 1 - Find EC2 instances with internet exposure and vulnerabilities that have a tag key
marked
// satheesh-vulnerability-hyperion
{“asset where asset.type IN (‘aws-ec2-describe-instances’) and finding.type IN
(‘INTERNET_EXPOSURE’) ”
  + “and with : VULN and with : (config from cloud.resource where api.name = ‘aws-ec2-
describe-instances’ ”
  + “and json.rule = ”
  + “tags[*].value contains \“satheesh-vulnerability-hyperion\”)”,
  “asset where asset.type IN ( ‘aws-ec2-describe-intances’ ) and with : VULN and asset.id IN ”
    + “(‘intothegreatwideopen’,‘i-0271f0b1944aa5e88’,‘i-081c48f704e4586b6’)”},
```

### Unit Test Case 2:

```
// Case: 2 - Find all EC2 assets with public IP and Internet access and are not running at this time
{“asset where asset.type IN (‘aws-ec2-describe-instances’,‘aws-ec2-describe-security-groups’)
and with : ”
  + “VULN and with : (config from cloud.resource where api.name = ‘aws-ec2-describe-
instances’ and json”
  + “.rule = state.name does not equal running and publicIpAddress exists and publicIpAddress
is not ”
  + “empty as X; config from cloud.resource where api.name = ‘aws-ec2-describe-security-
groups’ AND json”
  + “.rule = ipPermissions[*].ipRanges[*] contains 0.0.0.0/0 or
ipPermissions[*].ipv6Ranges[*].cidrIpv6 ”
  + “contains ::/0 as Y; filter ‘$.X.securityGroups[*].groupName contains $.Y.groupName’;
show X;)”,
  “asset where asset.type IN ( ‘aws-ec2-describe-instances’ , ‘aws-ec2-describe-security-groups’ )
and ”
    + “asset.id IN (‘intothegreatwideopen’,‘i-0271f0b1944aa5e88’,‘i-081c48f704e4586b6’)”},
```

### Unit Test Case 3:

```
// Case: 3 - Find me EC2 instances with internal source IP and network flow greater than 100K
bytes
{“asset where asset.type IN ( ‘aws-ec2-describe-instances’, ‘aws-ec2-describe-network-
interfaces’ ) AND ”
  + “finding.type IN ( ‘INTERNET_EXPOSURE’ ) and with : ” +
  “(network from vpc.flow_record where bytes > 100000 and source.ip IN ( 10.0.0.0/8,
172.16.0.0/16, 192.168”
    + “.0.0/24 ) limit search records to 500)”,
  “asset where asset.type IN ( ‘aws-ec2-describe-instances’ ) and with : VULN and asset.id NOT
IN ”
    + “(‘d2a826dbbd577dd5ad9864b03d1df815’,‘5caf2e021578fdc6b9bdf5b197df2e6b’)”},
```

### Unit Test Case 4:

```
// Case: 4 - Find EC2 assets that have customer managed policy and have high privileged role
finding
{“asset where asset.type IN (‘aws-ec2-describe-instances’) and finding.type IN (‘High Privileged
Role’) and ”
  + “with : (config from iam where grantedby.cloud.entity.tag exists AND
grantedby.cloud.policy.type IN ( ”
  + “‘Customer Managed Policy’ ))”,
  “asset where asset.type IN ( ‘aws-iam-list-users’ ) AND asset.id IN
( ‘BHEBSKEH83BZM6KXNNEM53’ ) AND ”
    + “finding.type IN(‘HIGH_PRIVILEGED_ROLE’)”},
```

### Unit Test Case 5:

```
// Case: 5 - Find EC2 assets accessible from the internet with remediable alerts
{“asset where asset.type IN (‘aws-ec2-describe-instances’) and finding.type IN
(‘INTERNET_EXPOSURE’) and ”
  + “with : (alert where alert.status IN (‘open’) and policy.remediable is true )”,
  “asset where asset.type IN ( ‘aws-ec2-describe-instances’ ) AND asset.id IN ( ‘ALERT001’ )
AND ”
    + “finding.type IN(‘INTERNET_EXPOSURE’)”},
```

### Unit Test Case 6:

// Case: 6 - Find assets with certain network properties (e.g., cloud network security (CNS)) and
configurations
// TODO { }

### Unit Test Case 7:

```
// Case: 7 - Show me up to 10 EC2 instances that transferred over 800K Bytes in the last 24
hours, and are
// not optimized for ebs and the machine instance is m4 large
{“asset where asset.type IN (‘aws-ec2-describe-instances’) and finding.type IN
(‘INTERNET_EXPOSURE’, ”
  + “‘MISCONFIGURATION’) and with : (network from vpc.flow_record where bytes >
800000 limit search records”
  + “ to 10) and with : (config from cloud.resource where api.name = ‘aws-ec2-describe-
instances’ and json”
  + “.rule = ebsOptimized is false and instanceType equals m4.large)”, “asset where asset.type
IN ”
  + “(‘aws-ec2-describe-instsances’) and finding.type IN
(‘INTERNET_EXPOSURE’,‘MISCONFIGURATION’) and asset”
  + “.id IN (‘i-100020003000’, ‘i-400050001000’)”},
```

### Unit Test Case 8:

// Case: 8 - Filter assets associated with certain events and configurations
// TODO { }

### Unit Test Case 9:

// Case: 9 - Filter assets associated with certain anomalies and
configurations
// TODO: { }

### Unit Test Case 10:

```
// Case: 10 - Find aws assets with vulnerabilities and have at least 3 attached VPCS
// config from cloud.resource where cloud.type = ‘aws’ AND api.name = ‘aws-ec2-describe-vpcs’
as X; count(X)
// greater than 3
{“ asset where cloud.type IN (‘aws’) and asset.class IN (‘Compute’) and with : vuln and with : ” +
  “(config where cloud.type = ‘aws’ and api.name = ‘aws-ec2-describe-vpcs’ as X; count(X)
greater than 3)”,
  “asset where cloud.type IN (‘aws’) and asset.class IN (‘Compute’) and with : vuln and asset.id
IN (‘id-1’,”
    + “‘id-2’))”}
```

Additional example process embodiments for AI-powered macros to process complex natural language processing (NLP) across domains will now be further described below.

### Process Embodiments for AI-Powered Macros to Process Complex NLP Queries Across Domains

FIG. 7 is a flow diagram for AI-powered macros to process complex natural language processing (NLP) across domains in accordance with some embodiments. In some embodiments, a process as shown in FIG. 7 is performed by a resource query language (RQL) and a Large Language Model (LLM), and techniques as similarly described above including the embodiments described above with respect to FIGS. 1-6.

At 702, processing a natural language query is performed as similarly described above with respect to FIGS. 1-6.

At 704, a cross-domain search is performed to generate a search result using a plurality of data source domains using a resource query language (RQL) and a Large Language Model (LLM) as similarly described above with respect to FIGS. 1-6.

At 706, the search result is output as similarly described above with respect to FIGS. 1-6.

FIG. 8 is another flow diagram for AI-powered macros to process complex NLP across domains in accordance with some embodiments. In some embodiments, a process as shown in FIG. 8 is performed by a resource query language (RQL) and a Large Language Model (LLM), and techniques as similarly described above including the embodiments described above with respect to FIGS. 1-6.

At 802, processing a natural language query is performed as similarly described above with respect to FIGS. 1-6.

At 804, a cross-domain search is performed to generate a search result using a plurality of data source domains using a resource query language (RQL) and a Large Language Model (LLM) as similarly described above with respect to FIGS. 1-6.

At 806, executing a plurality of RQLs in a ranked order and aggregating results for the search result are performed as similarly described above with respect to FIGS. 1-6.

At 808, the search result is output as similarly described above with respect to FIGS. 1-6.

Technical Challenges with Large Language Models (LLMS) for Domain Specific Languages

Pre-trained large language models (LLMs) are increasingly being used for generating code (e.g., programming languages for code that can be compiled and executed on a computer processor). Typically, these LLMs are trained on a large corpus of publicly available code, such as Structured Query Language (SQL) code.

As used herein, fine-tuning models, such as LLMs, generally refer to adapting the LLMs to specific tasks by leveraging their pre-existing knowledge (e.g., in contrast to training the LLMs from scratch with, for example, a randomly initialized model from an initial, large corpus of content) and tailoring them to specific needs and/or applications.

For domain specific languages (DSLs), such as the Resource Query Language (RQL) (e.g., RQL is used, for example, in the Prisma Cloud security service, which is a commercially available cloud-based security service provided by Palo Alto Networks, Inc., headquartered in Santa Clara, CA), fine-tuned models (e.g., artificial intelligence (AI)/machine learning (ML) models, including LLMs) are created using samples of valid DSLs and the corresponding natural language descriptions of the samples (e.g., as similarly described above with respect to FIGS. 1-8).

Specifically, the domain of RQL is query processing. It entails defining a high-level language to express policies using vocabulary from the cloud security domain, building a valid query sentence by populating suggestions from various domain resources, generating an executable query against various data sources, filtering results against given criteria, and presenting the results for visualization.

However, training fine-tuned models (e.g., AI/ML models, including LLMs) for domain specific languages (DSLs) has several technical challenges as will be summarized below.

A first technical challenge associated with training fine-tuned models for DSLs is related to the volume of training data. If the LLMs are fine-tuned on a small set of samples, then they tend to fall back to using popular languages such as SQL. Getting a large number of samples for fine tuning is typically a challenge as many of the queries are written by customers and may have personally identifiable information (PII) data (e.g., which typically cannot be used for training AI/ML models, such as LLMs, for various policy and/or legal reasons).

A second technical challenge associated with training fine-tuned models for DSLs is related to data recentness. Pre-trained models typically do not have current data (e.g., the training data is dated, in part, due to the time required in collecting the initial large corpus of training data and then training a new LLM using that collected initial large corpus of training data). As a result, LLMs can, in some cases, hallucinate when DSL queries require recent data or if the grammar for the DSL has been modified since the date associated with that initial set of training data (e.g., grammar related hallucinations for DLS can result due to the following examples of incorrect grammar usage: (i) lexicons, (ii) values, (iii) operators, and/or (iv) mismatched context).

A third technical challenge associated with training fine-tuned models for DSLs is related to prompt size limitations. Using LLMs served in a software as a service (SaaS) mode of operation typically limits the size of the prompts that can be provided as input to the LLMs. As such, this limits the size of proprietary data, such as some mappings that can be provided as input at the query generation time.

A fourth technical challenge associated with training fine-tuned models for DSLs is related to data curation. The performance of fine-tuned LLMs generally depends on the quality and diversity of the training data. Safeguards are typically implemented during the creation process of the training data to guarantee such properties are achieved. Domain-specific grammars capture all possible sentences that can manifest during runtime use that are not yet available for training. Furthermore, grammars impose strict constraints on the boundaries of generated sentences, thereby preventing an AI system from hallucinating.

As such, there exists a need for improved solutions for training of fine-tuned models for domain specific languages.

### Overview of Techniques for Grammar Powered Retrieval Augmented Generation for Domain Specific Languages

Accordingly, new and improved solutions for training of fine-tuned models for domain specific languages are provided as will now be described below.

Specifically, new and improved techniques for grammar powered retrieval augmented generation for domain specific languages are disclosed.

In some embodiments, a system/process/computer program product for grammar powered retrieval augmented generation for domain specific languages includes automatically generating a seed dataset for a domain specific language (DSL) (e.g., a resource query language (RQL), and wherein the RQL is generated for RQL for multi-domain security applications); expanding the seed dataset for the DSL using a Large Language Model (LLM); and validating the seed dataset for the DSL, wherein the seed dataset for the DSL is input to the LLM for fine tune training of the LLM (e.g., fine-tuned for a cloud security application).

As an example, the fine-tune trained LLM can automatically generate an RQL query in response to a natural language query using the fine-tuned LLM.

As another example, the fine-tune trained LLM can automatically generate a configuration policy in RQL from a natural language (NL) input.

As yet another example, the LLM is fine-tuned for performing automated entity extraction for multi-domain security applications. For instance, the LLM can be fine-tuned for performing a cross-domain search to generate a search result using a plurality of data source domains that includes using a planner, executor, and aggregator to collect distinct results from each of the plurality of data source domains. The LLM can also be fine-tuned for performing a natural language (NL) query for a plurality of data source domains for a cloud security application, in which the plurality of data source domains includes a configuration data set, an Identity and Asset Management (IAM) data set, and a vulnerability data set. In an example implementation, a comprehensive training data generation and query generation framework for DSLs is provided.

Also, the ability to establish grammar-directed constraints on the output sentences is provided, which will now be briefly described and will be further described below.

In this example implementation, a comprehensive training data generation and query generation framework for DSLs is composed of (1) the training data generation phase, and (2) the query generation (e.g., inference) phase.

With respect to the training data generation phase, first, the grammar of the language in the context for the LLM is provided, and the LLM is then prompted to generate RQLs using natural language questions (e.g., using the English language or another natural language can similarly be used for such natural language questions) corresponding to those RQLs. Second, all generated RQLs are then processed by an RQL parser for validation of the generated RQLs (e.g., to verify proper RQL grammar usage, etc.). Third, the valid RQLs are then used to form the training set for a fine-tuned model (e.g., using the valid RQLs as the fine-tuning training data set to generate a fine-tuned version of the LLM).

With respect to the inference phase, a significant concern with using LLMs for DSLs is the hallucinations that can result due to, for example, incorrect (i) lexicons, (ii) values, (iii) operators, and (iv) mismatched context, such as similarly discussed above. To reduce such potential hallucinations, the following techniques for implementing the inference phase are disclosed as will now be briefly described below.

Generally, the grammar of RQL in the context of the prompt is provided. For the values, information retrieval for fetching the correct values for various conditions can be used. First, prompt engineering can be applied to split the query into phrases that will require information retrieval. Second, for each phrase, the LLM can be used to identify the potential lexicon of the grammar as well as the value to be searched. Third, the lexicons are used to identify the data store on which a semantic search is to be performed. As an example, suppose that we have a query that includes the following phrase: “instances with vulnerability log4j and exposed to the Internet.” In this example query, there are two distinct phrases: (i) “vulnerability log4j,” and (ii) “exposed to the Internet.” As such, semantic searches can be performed on (1) the Prisma Cloud vulnerability data base (DB) to obtain the CVE IDs corresponding to log4j, and (2) on the Prisma Cloud policy DB to obtain the policy corresponding to “exposed to the Internet.” Finally, the retrieved information can then be provided in a prompt along with the grammar as context to a fine-tuned model to generate the relevant RQL.

These and various other embodiments and implementations for providing grammar powered retrieval augmented generation for domain specific languages will be further described below.

The disclosed techniques for grammar powered retrieval augmented generation for domain specific languages can be applied to generate a large, high quality training set of data (e.g., due in part to being grounded on the grammar and having additional guard rails of parsing for validating the grammar) for creating text to DSL, such as RQL, fine-tuned models.

In addition, the disclosed techniques for grammar powered retrieval augmented generation for domain specific languages facilitate the use of grammar along with information retrieval to significantly reduce the hallucinations for RQL generation use cases.

Moreover, the disclosed techniques for grammar powered retrieval augmented generation for domain specific languages can be applied to significantly lower the error rate for fine-tuned LLMs for DSLs. For example, based on experiments applying the disclosed techniques for fine-tuned LLMs for DSLs, the error rate dropped from more than 60% for just the fine-tuned model to less than 10% for the grammar empowered retrieval augmented DSL generation implemented solution.

Various example system embodiments for grammar powered retrieval augmented generation for domain specific languages will now be further described below.

### System Embodiments for Grammar Powered Retrieval Augmented Generation for Domain Specific Languages

FIG. 9 illustrates an overall architecture and workflow diagram for grammar powered retrieval augmented generation for domain specific languages (DSLs) in accordance with some embodiments. In this example implementation, the architecture and workflow for grammar powered retrieval augmented generation for domain specific languages includes three phases in a comprehensive framework: phase 1: generation; phase 2: expansion; and phase 3: validation, such as shown in FIG. 9 and as will be further described below.

Generally, large language models (LLMs) can be effectively and efficiently applied to various applications. As an example, LLMs can be advantageously applied to the cybersecurity field with their ability to understand and generate natural language text, such as described herein. Specifically, LLMs can be leveraged to assist cybersecurity practitioners in multiple areas, including, for example: (1) analyzing security data to help prioritize security operations, (2) generating summaries from sets of logs and alerts, and (3) creating code to help automate tasks. However, to generate LLMs effectively and efficiently for various applications like the cybersecurity field, it generally is a prerequisite to collect/curate vast amounts of diverse, high-quality data to either train the LLMs or to help them improve the accuracy and reliability of their responses (e.g., fine-tuning the LLMs).

As such, the disclosed techniques for grammar powered retrieval augmented generation for DSLs provide a comprehensive framework to generate large sets of high-quality data to empower LLMs to generate code (e.g., using a DSL, such as a security domain-specific query language as described herein) that is used to support an analysis and investigation of security events.

Referring to FIG. 9, the three phase framework has the ability to establish security-directed and grammar-directed constraints on the output sentences as further described below. As shown, the framework is composed of three phases: query generation, samples expansion, and dataset validation. Each of these three phases will now be further described below with respect to FIG. 9, which is an example application of the disclosed techniques for grammar powered retrieval augmented generation for DSLs, and specifically, for a security domain-specific query language (e.g., RQL).

### Phase 1: Query Generation

The generation of the examples generally involves a knowledge base that provides clear rules on what should be created for the LLMs. As such, it is preferable to avoid generating examples that would cause the LLMs to hallucinate (e.g., generate output that is incorrect and/or not consistent with any training data, etc.). In this example implementation, first-order logic (FOL), shown at first order logic sample generator 908 of FIG. 9, is applied to reason using facts and implications automatically, based on two key knowledge areas: (1) cloud security, and (2) the query language (e.g., RQL) to be used.

### Cloud Security Ontology

A Cloud Security Ontology 902 provides a comprehensive knowledge representation framework for all resources and services in a cloud environment and their roles in the context of security, based on the risks, threats, and vulnerabilities faced by the resources. The ontology defines how each cloud resource behaves, in terms of its role and risk faced in a security event.

In the cloud security space, customers are generally concerned about threats and risks affecting their cloud environments and the resources executing in those cloud environments. The cloud security ontology categorizes the different cloud resources into a particular class (e.g., Asset Class). For each asset class, there are different categories of threats (e.g., Finding types) that can impact them.

Table 2 provides the different finding types and those asset classes impacted by the findings.

TABLE 2
Finding Types and their Asset Classes

| Finding Type | Asset Class |
|---|---|
| COMMAND_AND_CONTROL | Compute |
| CREDENTIAL_ACCESS | Identity and Security |
| CROSS_ACCOUNT_TRUST | Identity and Security |
| DATA_EXFILTRATION | Compute |
| DEFENSE_EVASION | Identity and Security, Compute |
| DISCOVERY | Compute |
| HIGH_PRIVILEGED_ROLE | Identity and Security, Compute |
| INITIAL_ACCESS | Identity and Security, Compute |
| INTERNET_EXPOSURE | Compute, Database, Storage |
| KEYS_AND_SECRETS | Compute, Identity and Security |
| LATERAL_MOVEMENT | Identity and Security |
| MALWARE | Compute |
| MFA | Identity and Security, Storage |
| MISCONFIGURATION | Compute, Network, Storage, Identity |
| | and Security, Database |
| PRIVILEGE_ESCALATION | Identity and Security, Compute, |
| | Storage |
| RECONNAISSANCE | Compute |
| RESOURCE_HIJACKING | Compute, Identity and Security |
| UNAUTHORIZED_ACCESS | Identity and Security, Compute, |
| | Storage |
| UNENCRYPTED_DATA | Database, Storage, Network |
| UNUSED_PRIVILEGES | Identity and Security |
| USER_ANOMALY | Identity and Security |
| WEAK_PASSWORD | Identity and Security |

As shown in Table 2, an AWS EC2 cloud instance is a compute asset and can be impacted by finding types such as COMMAND_AND_CONTRQL, DATA_EXFILTRATION, and INTERNET_EXPOSURE. For example, an EC2 instance can be found to be in violation as it is configured with unrestricted outbound access to the Internet. In this case, the EC2 instance will be reported as violating the finding AWS EC2 instance with unrestricted outbound access to the Internet, which belongs to the INTERNET_EXPOSURE type.

### RQL Grammar

In this example implementation, the DSL being used for the LLM is the above-mentioned Prisma Cloud related Resource Query Language (RQL). RQL is a domain-specific structure language to help security professionals (e.g., information technology (IT)/network/security administrators, and/or other cloud/computing specialists) to gain security and operational insights about their deployments in cloud environments. Given its domain-specific nature, it is preferable to provide a complete definition of the RQL grammar to the LLM, to generate the samples (e.g., the samples can be used for fine-tuning training of the LLM, such as similarly discussed above). As such, an RQL grammar 906 is provided as shown in phase 1 of the framework illustrated in FIG. 9.

There are different types of RQL queries, depending on the investigation of interest to a user and the cloud entities involved, such as the following example for: asset, vulnerability, configuration (config), network, event, identity and access management (IAM), and/or cloud network security (CNS).

Below is an example of a basic structure of a query for the asset RQL type:

asset where {attribute_1} {operator} {attribute_1_value} and
{attribute_2}
{ operator} { attribute_2_value}

An example (complete) definition of the asset RQL is provided below in Table 3, which includes the attributes and operators; and Tables 4 and 5, which include the values used in the example types.

TABLE 3
Allowed Asset Attributes and Allowed Operators

| Attribute | Operators |
|---|---|
| asset.name (enclosed in single quotes) | =, IN |
| asset.type (allowed values: | =, IN |
| {list_of_asset_type_each_enclosed_in_single_quotes}) | |
| asset.class (allowed values: ‘Application and | =, IN |
| Content Delivery’, ‘Code’, ‘Compute’, | |
| ‘Database’, ‘Identity & Security’, ‘Network’, | |
| ‘Other’, ‘Storage’) | |
| cloud.type (allowed values: ‘aws’, ‘azure’, ‘gcp’, | =, IN |
| ‘alibaba_cloud’, ‘oci’, ‘ibm’) | |
| cloud.account (enclosed in single quotes) | =, IN |

TABLE 4
Allowed Finding Attributes and Allowed Operators

| Attribute | Operators |
|---|---|
| finding.name (allowed values: | =, IN, CONTAINS ALL |
| {list_of_finding_names_each_enclosed_in_single_quotes}) | (enclose values in parentheses) |
| finding.type (allowed values: | IN |
| ‘COMMAND_AND_CONTROL’, | |
| ‘CREDENTIAL_ACCESS’, | |
| ‘CROSS_ACCOUNT_TRUST’, | |
| ‘DATA_EXFILTRATION’, | |
| ‘DEFENSE_EVASION’, ‘DISCOVERY’, | |
| ‘HIGH_PRIVILEGED_ROLE’, | |
| ‘INITIAL_ACCESS’, | |
| ‘INTERNET_EXPOSURE’, | |
| ‘KEYS_AND_SECRETS’, | |
| ‘LATERAL_MOVEMENT’, ‘MALWARE’, | |
| ‘MFA’, ‘MISCONFIGURATION’, | |
| ‘PRIVILEGE_ESCALATION’, | |
| ‘RECONNAISSANCE’, | |
| ‘RESOURCE_HIJACKING’, | |
| ‘UNAUTHORIZED_ACCESS’, | |
| ‘UNENCRYPTED_DATA’, | |
| ‘UNUSED_PRIVILEGES’, | |
| ‘USER_ANOMALY’, ‘WEAK_PASSWORD’) | |
| finding.severity (allowed values: | IN |
| ‘informational’, ‘low’, ‘medium’, ‘high’, ‘critical’) | |

TABLE 5
Allowed Vulnerability Attributes and Allowed Operators

| Attribute | Operators |
|---|---|
| WITH: vuln WHERE id (allowed values: | IN |
| {list_of_vuln_values_each_enclosed_in_single_quotes}) | (enclose |
| | values in |
| | paren- |
| | theses) |
| WITH: vuln WHERE severity (allowed | >, >= |
| values: informational, low, medium, high, | |
| critical) | |
| WITH: vuln WHERE cvss.score (allowed | >, >= |
| range: 0 to 10 as an integer) | |

### RQL Description Templates

In this example implementation, there are additional constraints defined by the different RQL types, beyond the syntactic validation enforced by the language grammar. The additional constraints represent the semantic validation performed at runtime to determine whether or not a query should be executed or not. For example, the grammar allows the construction of queries with unbounded levels of nesting, yet this is not desirable in some cases as the corresponding search operation can be performed across large volumes of data. As such, RQL description templates 904 is provided as shown in phase 1 of the framework illustrated in FIG. 9.

The semantic validation is presented to the LLM in the prompt sent, as a series of rules.

Below is an example prompt submitted to the LLM to generate asset RQL samples, as shown at 910 in FIG. 9 for generating RQL dataset (seed) samples.

“Your task is to create an AQL query. To solve the problem, perform the following:
1. Always start the AQL query with “asset where”.
2. The AQL query should always include one and only one of the following asset attributes: asset.type, asset.class.
3. The AQL query should always include at least one finding attribute or one vulnerability attribute.
4. Choose one or more attributes from the list provided above that best represent the criteria for your query and do not deviate from the given list.
5. Select the appropriate operator for each attribute only based on the allowed operators listed above and do not deviate from given constraints.
6. Fill in the attribute value(s) according to the given instructions for each attribute (enclosed in single quotes when required).
7. If multiple attributes are used, combine them using the “and” logical operator.”

### Examples of FOL Rules

First Order Logic (FOL) (e.g., as shown at 908 in FIG. 9) is used to formally define the set of rules to be used in this framework to generate the samples (e.g., as shown at 910 in FIG. 9). In this example implementation, FOL helps to reason using facts and implications automatically, based on two key knowledge areas: cloud security and the query language selected (e.g., RQL). FOL allows for defining facts and rules to assert relationships among different objects, such as the resources and findings defined in this example implementation.

Below is an example of the facts and rules defined using FOL for the asset RQL type. The definition allows for mathematically defining what is allowed when generating samples, which facilitates generating correct samples to avoid possible hallucinations when these samples are passed to an LLM.

### Logical Facts

In the below example of logical facts, the objects and their corresponding elements are listed. A subset of all possible elements is presented for assetType and findingName, given the large number of elements each one contains.

```
  assetClass { Compute, Identity & Security, Database, Storage, Network}
assetType { Alibaba ECS Instance, Alibaba RAM User, Alibaba ECS Security Group,
  Amazon API Gateway REST API, CloudWatch Log Group, EC2 VPC Endpoint,
  EC2 Instance, EC2 Internet Gateway, EC2 Network ACL,
  EC2 Network Interface, EC2 VPC Route Table, EC2 Security Group,
  Amazon VPC Flow Logs, AWS IAM Policy, AWS IAM Access Key,
  AWS IAM Group, AWS IAM MFA Device, AWS IAM Role,
  AWS IAM Server Certificate, AWS IAM SSH Public Keys, AWS IAM User,
  Azure Active Directory Group, Azure Active Directory Group Members,
  Azure Active Directory Group Settings,
  Azure Active Directory IAM Group,
  Azure Active Directory Named Location,
  Active Directory Service Principal App,
  Azure Active Directory User, Azure Activity Log Alert,
  Azure AD User, Azure Cosmos DB, Azure DNS Zones, Azure MySQL Server,
  Azure Load Balancer, Azure Network NAT Gateway,
  Azure Network Interface, Azure Security Group,
  Azure PostgreSQL Server, Google Compute Image,
  Google Compute Engine Disk Snapshot,
  Compute Instance Group, Google Compute Engine Instance Template,
  Compute Engine VM Instance Group, Google Compute Engine VM Instance,
  Google Compute Engine Network Interface,
  Google Cloud Load Balancer Internal Backend Service,
  Google Compute NAT, Compute Network Endpoint Group,
  Google VPC Network,
  Google VPC Subnet, IBM IAM Policy, IBM IAM Role, IBM IAM Service ID,
  IBM IAM Trusted Profile, IBM IAM User, IBM Kubernetes Cluster,
  IBM Kubernetes Worker, IBM MySQL Deployment,
  IBM Cloud Block Storage Bucket, IBM PostgreSQL Deployment,
  OCI Certificate Authority, OCI Compute Image, OCI Compute Instance,
  OCI VNIC, OCI Container Image, OCI Kubernetes Cluster,
  OCI Database Autonomous Database, OCI Database DB Home,
...}
      findingName { Alibaba Cloud RAM password policy does not have a lowercase
character,
    Alibaba Cloud RAM password policy does not have a minimum of 14 characters,
    AWS Inactive users for more than 30 days,
    AWS NAT Gateways are not being utilized for the default route,
    GCP HTTPS Load balancer is configured with SSL policy having TLS version 1.1 or
lower,
    GCP HTTPS Load balancer SSL Policy not using restrictive profile,
    GCP Kubernetes cluster Application-layer Secrets not encrypted,
    AWS S3 bucket has global view ACL permissions enabled,
    AWS S3 bucket has policy overly permissive to VPC endpoints,
    AWS S3 Bucket Policy allows public access to CloudTrail logs,
    AWS VPC Flow Logs not enabled,
    AWS VPC gateway endpoint policy is overly permissive,
    AWS VPC not in use,
    Traffic to a suspicious IP address associated with Backdoor activity,
    Traffic to a suspicious IP address associated with Botnet activity,
    Traffic to a suspicious IP address associated with DDOS activity,
    AWS Access key enabled on root account,
    AWS Access keys are not rotated for 90 days,
    AWS EC2 instance that is reachable from untrusted internet source to ports with high risk,
    AWS EC2 instance with unrestricted outbound access to internet,
    Azure Cosmos DB (PaaS) instance reachable from untrusted internet source,
    Azure MySQL (PaaS) instance reachable from untrusted internet source on TCP port 3306,
    Azure PostgreSQL (PaaS) instance reachable from untrusted internet source on TCP port
5432,
    Azure SQL Server (PaaS) reachable from any untrusted internet source,
    GCP users with ‘Editor’ role on org level,
    GCP users with ‘Owner’ role on folder level,
    Suspicious activity in Web services,
    Suspicious login activity,
    Traffic on unusual port to a server inside monitored cloud accounts,
    Traffic on unusual port to a server outside monitored cloud accounts,
    Traffic with unusual protocol to a server inside monitored cloud accounts,
    Traffic with unusual protocol to a server outside monitored cloud accounts,
    Unusual high volume data transfer activity from a monitored cloud account,
    ...}
```

| | |
|---|---|
| findingType | {‘COMMAND_AND_CONTROL’, |

```
‘CREDENTIAL_ACCESS’,‘CROSS_ACCOUNT_TRUST’,
    ‘DATA_EXFILTRATION’, ‘DEFENSE_EVASION’, ‘DISCOVERY’,
    ‘HIGH_PRIVILEGED_ROLE’, ‘INITIAL_ACCESS’, ‘INTERNET_EXPOSURE’,
    ‘KEYS_AND_SECRETS’, ‘LATERAL_MOVEMENT’, ‘MALWARE’, ‘MFA’,
    ‘MISCONFIGURATION’, ‘PRIVILEGE_ESCALATION’, ‘RECONNAISSANCE’,
```

| | |
|---|---|
| ‘RESOURCE_HIJACKING’, | ‘UNAUTHORIZED_ACCESS’, |

```
‘UNENCRYPTED_DATA’,
    ‘UNUSED_PRIVILEGES’, ‘USER_ANOMALY’, ‘WEAK_PASSWORD’}
      cloudType {AWS, Azure, GCP, OCI, IBM, Alibaba}
associated(COMMAND_AND_CONTROL, (Compute))
associated(CREDENTIAL_ACCESS, (Identity and Security))
associated(CROSS_ACCOUNT_TRUST, (Identity and Security))
associated(DATA_EXFILTRATION, (Compute))
associated(DEFENSE_EVASION, (Identity and Security, Compute))
associated(DISCOVERY, Compute)
associated(HIGH_PRIVILEGED_ROLE, (Identity and Security, Compute))
associated(INITIAL_ACCESS, (Identity and Security, Compute))
associated(INTERNET_EXPOSURE, (Compute, Database, Storage))
associated(KEYS_AND_SECRETS, (Compute, Identity and Security))
associated(LATERAL_MOVEMENT, (Identity and Security))
associated(MALWARE, (Compute))
associated(MFA, (Identity and Security, Storage))
associated(MISCONFIGURATION, (Compute, Network, Storage, Identity and Security,
Database))
associated(PRIVILEGE_ESCALATION, (Identity and Security, Compute, Storage))
associated(RECONNAISSANCE, (Compute))
associated(RESOURCE_HIJACKING, (Compute, Identity and Security))
associated(UNAUTHORIZED_ACCESS, (Identity and Security, Compute, Storage))
associated(UNENCRYPTED_DATA, (Database, Storage, Network))
associated(UNUSED_PRIVILEGES, (Identity and Security))
associated(USER_ANOMALY, (Identity and Security))
associated(WEAK_PASSWORD, (Identity and Security))
```

### Condition Generating Rules

The following rules were used to capture the relationship between the different facts and the queries that can be generated for the asset RQL type. As an example, the rules would allow to create a query that involves an asset class and a finding type, as long as they are associated per the set of FOL facts defined.

Below is an example of condition generating rules for creating a query that involves an asset class and a finding type as described above.

```
if assetType ?at and cloudType ?ct
  and findingName ?fn
  and associated ?ct ?fn
  and associated ?at ?ct
then add a condition in the query for findingName ?fn
if assetClass ?ac and findingType ?ft
  and associated ?ac ?ft
then add a condition in the query for findingType ?ft
```

### Phase 2: Sample Expansion

Once a first set of samples have been generated (e.g., as shown at 910 in FIG. 9 and as described above in Phase 1 of the framework shown in FIG. 9), the number of samples is expanded by leveraging LLMs and using different techniques as will now be described with respect to Phase 2 of the framework shown in FIG. 9. As shown in FIG. 9, an iterative prompt generation component 912 can automatically generate such new prompts 914 that are provided as input into LLM 916 to expand a (final) RQL dataset 918. It should be noted that one sample includes two parts: (1) the RQL query generated, and (2) the corresponding natural language (NL) representation for that query.

In this example implementation, multiple techniques can be used to expand the samples generated (e.g., the RQL dataset as shown at 918 in FIG. 9), including the following example strategies, which can be implemented by iterative prompt generation component 912.

As a first example strategy to expand the samples generated, given an RQL query and its NL representation, variations of the NL can be automatically generated using the LLM, while keeping the same query.

As a second example strategy to expand the samples generated, given a set of samples using single values with same attributes (e.g., one asset type and one finding name in the query), queries with multiple values of those same attributes can be automatically generated using the LLM.

As a third example strategy to expand the samples generated, given a set of samples using single values of the same asset attribute but different filtering criteria (e.g., finding or vulnerability), queries that mix the seed queries (e.g., RQL dataset (seed) as shown at 910 in FIG. 9, which can be used to drive the prompt engineering as described herein) can be automatically generated using the LLM.

An example prompt (914) that can be provided to LLM 916 to generate samples using this third example strategy is as follows:

“the query asset class = compute and finding type = Internet
Exposure and the query asset class = compute and vulnerability >=
critical, generate a new query of the form: asset class = compute
and finding type = Internet Exposure and vulnerability >=
critical.”

### Phase 3: Dataset Validation

The third and final phase is the validation of the RQL dataset. In this example implementation, validation is driven by analyzing the distribution of data across asset types, vulnerabilities, findings, language operators, etc., and the probability of occurrence based on past policies. As shown in FIG. 9, Phase 3 of the framework provides for validation of the RQL dataset using sampling (e.g., 95% confidence interval) as shown at 920, an RQL subset 922, and an RQL Linter tool component 924 (e.g., a syntax verification tool for analyzing every RQL query submitted to it, and checking for syntactic correctness based on the RQL grammar).

The particular domain query (Asset Query) is cloud-agnostic, but the analysis can be configured to cover all the cloud types, such as Amazon Web Services (AWS), Google Cloud Platform (GCP), Oracle Cloud (OCI), Alibaba Cloud, IBM Cloud, Microsoft Azure, etc.

Consider the AWS cloud type. Example highlights of the nature of data associated with the AWS cloud type include the following.

First, the top ten asset types based on security interests are: EC2 Instance, Security Groups, Network Interfaces, S3 Bucket Access Control Lists (ACLs), Relational DB Instances, Credentials, Elastic Kubernetes Service (EKS) Clusters, Cloud Front Distributions, Load Balancers, and Elastic Search Domain.

Second, vulnerabilities affect a very small set of asset types but in significant volume.

Third, findings are not uniformly distributed.

Knowing the nature of data distribution facilitates an automated and accurate generation of a suitable validation procedure.

In this example implementation, the overall population is approximately 5,000 generated queries across all types of assets with various ranges of findings and vulnerabilities.

Below is an example implementation of a validation procedure.

Randomly select 500 (10% of the population) samples from the
generated dataset.
Compute the overall score of the samples by using the following
metrics: (1) Syntactic Correctness: the query passed syntax checks
or otherwise; and (2) Query Form: a score based on the query size,
parameters, and operator coverage.
Epistemological Adequacy: determines the knowledge coverage of the
generated samples. To estimate this factor, we execute the queries
against the backend server and compute the distribution coverage
across asset types. By comparing the results against the known
distribution in security policies and popular queries (saved
searches), we arrive at a reasonable estimate.
Repeat the above steps n times (e.g., 10 times) and compute the
mean score of the dataset.

FIG. 10 is an example configuration policy for a cloud security service that is implemented in RQL in accordance with some embodiments. As similarly discussed above, configuration policies for the Prisma Cloud security service are generally written in the RQL format. The above-described techniques can be applied to facilitate generation of RQL formatted configuration policies from natural language input from users to the fine-tuned LLM.

Additional example process embodiments for grammar powered retrieval augmented generation for domain specific languages will now be further described below.

### Process Embodiments for Grammar Powered Retrieval Augmented Generation for Domain Specific Languages

FIG. 11 is a flow diagram for grammar powered retrieval augmented generation for domain specific languages in accordance with some embodiments. In some embodiments, a process as shown in FIG. 11 is performed using an automatically generated resource query language (RQL) dataset and a fine-tuned Large Language Model (LLM), and techniques as similarly described above including the embodiments described above with respect to FIGS. 1-9.

At 1102, automatically generating a seed dataset for a domain specific language (DSL) (e.g., RQL or another form of DSL) is performed as similarly described above with respect to FIG. 9.

At 1104, expanding the dataset for the DSL using a Large Language Model (LLM) is performed as similarly described above with respect to FIG. 9.

At 1106, validating the dataset for the DSL is performed, wherein the dataset for the DSL is input to the LLM for fine tune training of the LLM as similarly described above with respect to FIG. 9.

FIG. 12 is another flow diagram for grammar powered retrieval augmented generation for domain specific languages in accordance with some embodiments. In some embodiments, a process as shown in FIG. 12 is performed using an automatically generated resource query language (RQL) dataset and a fine-tuned Large Language Model (LLM), and techniques as similarly described above including the embodiments described above with respect to FIGS. 1-9.

At 1202, automatically generating a seed dataset for a domain specific language (DSL) (e.g., RQL or another form of DSL) is performed as similarly described above with respect to FIG. 9.

At 1204, expanding the dataset for the DSL using a Large Language Model (LLM) is performed as similarly described above with respect to FIG. 9.

At 1206, validating the dataset for the DSL is performed, wherein the dataset for the DSL is input to the LLM for fine tune training of the LLM as similarly described above with respect to FIG. 9.

At 1208, generating an RQL query in response to a natural language query using the fine-tuned LLM is performed as similarly described above with respect to FIGS. 1-9.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a processor configured to:
automatically generate a seed dataset for a domain specific language; (DSL), wherein the DSL includes a resource query language (RQL), and wherein the automatically generating of the seed dataset comprises to:
generate a natural language representation of the RQL to obtain the seed dataset;
expand, using a Large Language Model (LLM), the seed dataset for the DSL to obtain an expanded dataset for the DSL, comprising to:
perform one or more of the following:
A) generate a plurality of variations of the natural language representation to obtain the expanded dataset for the DSL;
B) for a first set of samples using single asset values having same asset attributes, generate queries having a plurality of asset values for the same asset attributes to obtain the expanded dataset for the DSL; or
C) for a second set of samples using single asset values having same asset attributes and have different filtering criteria, generate queries that mix the natural language of the RQL to obtain the expanded dataset for the DSL, wherein the second set of samples includes at least one finding attribute or one vulnerability attribute; and
validate the expanded dataset for the DSL, wherein the expanded dataset for the DSL is input to the LLM for fine tune training of the LLM; and
a memory coupled to the processor and configured to provide the processor with instructions.

2. (canceled)

3. The system of claim 1, wherein the RQL is generated for RQL for multi-domain security applications.

4. The system of claim 1, wherein the LLM is fine-tuned for a cloud security application.

5. The system of claim 1, wherein the LLM is fine-tuned for performing automated entity extraction for multi-domain security applications.

6. The system of claim 1, wherein the LLM is fine-tuned for performing a cross-domain search to generate a search result using a plurality of data source domains that includes using a planner, executor, and aggregator to collect distinct results from each of the plurality of data source domains.

7. The system of claim 1, wherein the DSL is a resource query language (RQL), wherein the LLM is fine-tuned for performing a natural language (NL) query for a plurality of data source domains for a cloud security application, and wherein the plurality of data source domains includes a configuration data set, an Identity and Asset Management (IAM) data set, and a vulnerability data set.

8. The system of claim 1, wherein the processor is further configured to:
generate an RQL query in response to a natural language query using the fine-tuned LLM.

9. The system of claim 1, wherein the DSL is a resource query language (RQL), and wherein the processor is further configured to:
automatically generate a configuration policy in RQL from a natural language (NL) input.

10. The system of claim 1, wherein the LLM is fine-tuned for performing a cross-domain search to generate a search result using a plurality of data source domains to collect distinct results from each of the plurality of data source domains, and wherein the processor is further configured to:
automatically generate an output in response to a natural language query, wherein one or more of the plurality of data source domains are searched using queries in RQL.

11. A method, comprising:
automatically generating a seed dataset for a domain specific language (DSL), wherein the DSL includes a resource query language (RQL), and wherein the automatically generating of the seed dataset comprises:
generating a natural language representation of the RQL to obtain the seed dataset;
expanding, using a Large Language Model (LLM), the seed dataset for the DSL to obtain an expanded dataset for the DSL, comprising:
performing one or more of the following:
A) generating a plurality of variations of the natural language representation to obtain the expanded dataset for the DSL;
B) for a first set of samples using single asset values having same asset attributes, generating queries having a plurality of asset values for the same asset attributes to obtain the expanded dataset for the DSL; or
C) for a second set of samples using single asset values having same asset attributes and have different filtering criteria, generating queries that mix the natural language of the RQL to obtain the expanded dataset for the DSL, wherein the second set of samples includes at least one finding attribute or one vulnerability attribute; and
validating the seed dataset for the DSL, wherein the seed dataset for the DSL is input to the LLM for fine tune training of the LLM.

12. (canceled)

13. The method of claim 11, wherein the RQL is generated for RQL for multi-domain security applications.

14. The method of claim 11, wherein the LLM is fine-tuned for a cloud security application.

15. The method of claim 11, further comprising:
automatically generating an RQL query in response to a natural language query using the fine-tuned LLM.

16. The method of claim 11, wherein the DSL is a resource query language (RQL), further comprising:
automatically generating a configuration policy in RQL from a natural language (NL) input.

17. A computer program product embodied in a non-transitory computer readable medium and comprising computer instructions for:
automatically generating a seed dataset for a domain specific language (DSL), wherein the DSL includes a resource query language (RQL), and wherein the automatically generating of the seed dataset comprises:
generating a natural language representation of the RQL to obtain the seed dataset;
expanding, using a Large Language Model (LLM), the seed dataset for the DSL to obtain an expanded dataset for the DSL, comprising:
performing one or more of the following:
A) generating a plurality of variations of the natural language representation to obtain the expanded dataset for the DSL;
B) for a first set of samples using single asset values having same asset attributes, generating queries having a plurality of asset values for the same asset attributes to obtain the expanded dataset for the DSL; or
C) for a second set of samples using single asset values having same asset attributes and have different filtering criteria, generating queries that mix the natural language of the RQL to obtain the expanded dataset for the DSL, wherein the second set of samples includes at least one finding attribute or one vulnerability attribute; and
validating the seed dataset for the DSL, wherein the seed dataset for the DSL is input to the LLM for fine tune training of the LLM.

18. (canceled)

19. The computer program product of claim 17, wherein the RQL is generated for RQL for multi-domain security applications.

20. The computer program product of claim 17, wherein the LLM is fine-tuned for a cloud security application.

21. The system of claim 1, wherein the expanding of the seed dataset comprises to generate a plurality of variations of the natural language representation to obtain the expanded dataset for the DSL.

22. The system of claim 1, wherein the expanding of the seed dataset comprises to, for a first set of samples using single asset values having same asset attributes, generate queries having a plurality of asset values for the same asset attributes to obtain the expanded dataset for the DSL.

23. The system of claim 1, wherein the expanding of the seed dataset comprises to, for a second set of samples using single asset values having same asset attributes and have different filtering criteria, generate queries that mix the natural language of the RQL to obtain the expanded dataset for the DSL, wherein the second set of samples includes at least one finding attribute or one vulnerability attribute.
